(19) United States
(12) Patent Application Publication
(10) Pub. No.: US 2021/0105332 A1
(43) Pub. Date: Apr. 8, 2021

(54) INTELLIGENT STATUS INDICATORS FOR PREDICTED AVAILABILITY OF USERS

(71) Applicant: MICROSOFT TECHNOLOGY LICENSING, LLC, Redmond, WA (US)

(72) Inventors: Vincent BELLET, Kirkland, WA (US); Paul SIM, Redmond, WA (US); Michael H. HILL, Shoreline, WA (US); Marc Christophe POTTIER, Redmond, WA (US); Karvell LI, Bellevue, WA (US)

(21) Appl. No.: 16/595,363

(22) Filed: Oct. 7, 2019

(51) Int. Cl. H04L 29/08

(52) U.S. Cl. CPC H04L 67/24

(57) ABSTRACT

The techniques disclosed herein enable systems to provide status indicators for intended recipients about a person's future or predicted availability. A system can analyze contextual information from a number of different resources and provide status indicators about a person when parameters of a person's status meet one or more criteria. For example, a system may deliver a status indicator describing a person's status when a time, duration, or type of a status, such as a vacation or holiday, meet one or more criteria. By controlling the display of status indicators using one or more criteria, a system only shows a particular user's status indicators that matter to a particular recipient. A system can deliver timely, contextually relevant status indicators while mitigating distractions that may be caused by a large number of unwanted status indicators. Timely status indicators also allow users to establish efficient collaboration protocols with other users.

### BACKGROUND

There are number of existing tools that allow users to collaborate and share information. For instance, calendaring programs allow users to establish appointments between each other, email and chat programs allow users to share messages, files, and other information. In some existing systems, communication programs can provide a status of a particular user. For instance, in a chat user interface, a system may generate a visual indicator signifying a person's current availability.

Although there are a number of different types of systems and applications that allow users to collaborate, today's systems still have a number of shortcomings. For instance, there are existing capabilities to automatically provide a user with targeted and contextually relevant status information. Existing systems generally require users to manually interact with a number of different systems to retrieve and compile useful status information. Users may be required to gain status information from a chat program and a calendaring program to obtain contextually useful information. Such manual steps can be disruptive to a person's workflow and highly inefficient when it comes to helping a person establish a collaboration protocol with a group of people. Such drawbacks of existing systems can lead to loss of productivity as well as inefficient use of computing resources.

### SUMMARY

The techniques disclosed herein enable systems to provide status indicators for intended recipients about a person's future or predicted availability. A system can analyze contextual information from a number of different resources and provide status indicators about a person when parameters of that person's status meet one or more criteria. For example, a system may deliver a status indicator describing a person's status when a time, duration, or a type of status, such as a vacation or holiday, meet one or more criteria. By controlling the display of status indicators using established criteria, a system only shows a particular user's status that matter to a particular recipient. A system can also control the display of status indicators by an analysis of user activity and only deliver status indicators to recipients having a threshold level of collaboration with a person who is the subject of the status indicator. Thus, a system can deliver timely, contextually relevant status indicators while mitigating distractions that may be caused by a large number of unwanted status indicators. Timely delivery of a status indicator about a person's future availability enables a recipient of the status indicator to establish an efficient collaboration protocol with other people. In addition, timely displayed status indicators allow users to adjust their interaction with a computer before they take action, e.g., draft an email, setup a meeting, or draft a chat entry. Timely displayed status indicators also mitigate the need for the users to manually retrieve status data from multiple sources.

The techniques disclosed herein can also provide customized status indicators to provide the right level of information regarding a person's future availability. For instance, a status indicator may describe a particular status of a user with respect to a deadline or a predetermined date. Such an indicator may state that a person has a vacation that starts in three days of a current time, or an indicator may state that a person has a vacation that starts within two days of a specific deadline. The system can also display a duration of a particular status. Such an indicator may state that a person has a vacation that starts in three days and lasts for a week. This type of indicator can be conditionally displayed if the duration meets one or more criteria, such as a threshold length, threshold minimum, etc. By providing information about a user's unavailability with respect to a predetermined date, a system can readily provide status information that pertains to a particular event. The system can also conditionally deliver status information based on a policy to filter certain types of status information. This allows the system to deliver contextually relevant status information without inundating users with unwanted information that can detract from the efficiency of a system. In addition, the system can deliver a status indicator within a particular operating environment that is convenient for each user. For instance, if a recipient of a status indicator typically operates within a particular application, the status indicator can be delivered to a user interface within that particular application. A status indicator may also be embedded into a file displayed to a person using any type of application.

In some configurations, the system can provide a status indicator with a recommendation about one or more selected users. A recommendation may suggest when two or more users should meet or how two or more users should collaborate. The techniques disclosed herein can be used to establish a collaboration protocol between people who are already connected. For example, if a group of people are involved in a chat or a conference call, system can analyze communication data and other contextual data and determine a time that is optimal for particular users to collaborate. The system can detect due dates for a workflow process and determine conflicts between one or more schedules and then determine a time when particular users should take action. The system can also use due dates and scheduling data to determine when a status indicator should be delivered. As described in more detail herein, system can also determine a level of detail to provide within a status indicator or a recommendation that is based on the context of each user. Timely delivery of the right information, detailed at the right level, which is delivered to a specific platform, can optimize a user's efficiency, the efficiency of a collaboration protocol between users, and the efficiency in which computing devices are utilized.

The techniques disclosed herein can provide a number of technical benefits. For instance, by providing a status indicator within a particular application that is selected for a particular recipient, a system can increase the utilization of a status indicator. This can provide status information that may not be otherwise identified by the recipient. In addition, automatic delivery of the status information mitigates or eliminates the need for the recipient to search for the status information from different resources. Such techniques can increase the efficiency of a computing system by reducing the number of times a user needs to interact with a computing device to obtain information. Thus, various computing resources such as network resources, memory resources, and processing resources can be reduced.

The efficiencies derived from the analysis described above can also lead to other efficiencies. In particular, by automating a number of different processes for generating status notifications, user interaction with the computing device can be improved. The reduction of manual data entry and improvement of user interaction between a human and a computer can result in a number of other benefits. For instance, by reducing the need for manual entry, inadvertent inputs and human error can be reduced. This can ultimately lead to more efficient use of computing resources such as memory usage, network usage, processing resources, etc.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 illustrates a system used in an example scenario involving a communication system for illustrating aspects of the present disclosure.

FIG. 2A illustrates an example user interface displaying a status indicator based on a first scenario.

FIG. 2B illustrates an example user interface displaying a status indicator based on a second scenario.

FIG. 2C illustrates an example user interface displaying a status indicator based on a third scenario.

FIG. 2D illustrates an example user interface displaying a status indicator based on a fourth scenario.

FIG. 2E illustrates an example user interface controlling the display of a status indicator based on another user scenario that does not include a threshold collaboration level between the users.

FIG. 3 illustrates a system used in an example scenario involving a multiuser editing system for illustrating aspects of the present disclosure.

FIG. 4A illustrates an example user interface of a multiuser editing system for displaying a status indicator based on a scenario.

FIG. 4B illustrates an example user interface of a multiuser editing system for displaying a status indicator of a first user based on a scenario.

FIG. 4C illustrates an example user interface of a multiuser editing system for filtering a status indicator of a user based on a scenario.

FIG. 4D illustrates an example user interface of a multiuser editing system for displaying a status indicator of a second user based on a scenario.

FIG. 5 illustrates a system used in an example scenario involving a system for selecting a delivery mechanism for a status indicator based on activity data or contextual data.

FIG. 6 illustrates an example scenario where scores associated with individual factors are used to select the delivery mechanisms.

FIG. 7 illustrates an example scenario where weighted scores associated with individual factors are used to select delivery mechanisms.

FIG. 8 illustrates an example of a menu of an application can be selected as a delivery mechanism and configured to convey a status indicator to a recipient using an in-app message optimized to minimize interference of a user's workflow.

FIG. 9A illustrates an example of a user interface of an application can be selected as a delivery mechanism and configured to convey a status indicator to a recipient using an in-app message optimized to minimize interference of a user's workflow.

FIG. 9B illustrates an example of a ribbon of an application can be selected as a delivery mechanism and configured to convey a status indicator to a recipient using an in-app message optimized to minimize interference of a user's workflow.

FIG. 10 is a flow diagram illustrating aspects of a routine for computationally efficient generation and management of status indicators.

FIG. 11 is a computing system diagram showing aspects of an illustrative operating environment for the technologies disclosed herein.

FIG. 12 is a computing architecture diagram showing aspects of the configuration and operation of a computing device that can implement aspects of the technologies disclosed herein.

### DETAILED DESCRIPTION

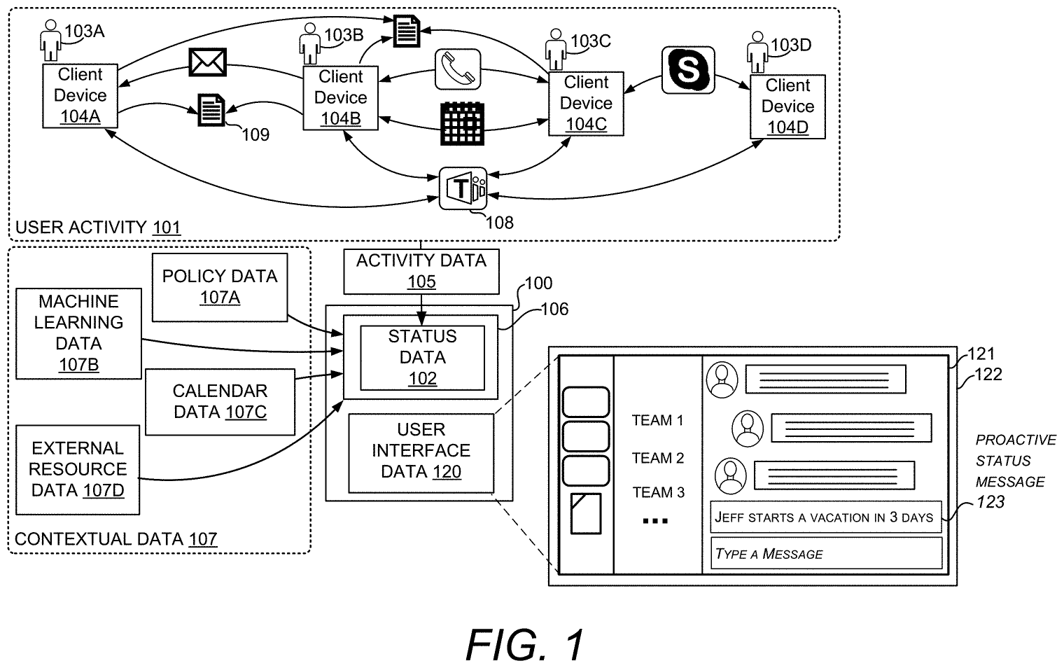

FIG. 1 illustrates a system 100 in an example scenario for illustrating aspects of the present disclosure. The techniques disclosed herein improve existing systems by provide status indicators 123 for intended recipients about the person's future or predicted availability. The system 100 can analyze activity data 105 from user activity 101 and contextual data 107 from a number of different resources and provide status indicators about a particular person when the status indicator meets one or more criteria. Generally described, a number of users 103 can collaborate through a variety of applications 108, documents 109 via a number of client computing devices 104. The user activity 101 can be used to generate activity data 105, which can include documents, voice data, video data, chat channel data, call records, etc. The system 100 can analyze any type of user activity 101 such as, but not limited to, a user's interaction with a file, email program, channel program, private chat program, voice or video program, a calendar database, etc. The activity data 105 and the contextual data 107 can be used to determine when a status indicator 123 is to be delivered, and to which user 103 the status indicator 123 is to be delivered.

For illustrative purposes, a status of a user can also be referred to herein as a “status change.” Data defining a status, or a status change, may define parameters such as a start time and a stop time of a particular status. A status or a status change can have a “status type,” such as a meeting, vacation, holiday, or any other label that may apply to that person's level of availability or activities during a particular time. A person's level of availability may be quantified by a score, wherein one of a scale could indicate that a person is completely unavailable and the score progresses to the other end of the scale when the person becomes more available, e.g., can take calls, can participate in chat sessions, can participate in calls, etc. A status indicator 123 can be communicated and displayed to a user when the status type meets one or more criteria or when the person's level of availability reaches an availability threshold.

In one illustrative example, the activity data 105 defining the user activity 101 can be parsed and analyzed to identify when two or more users have a threshold level of collaboration. In addition, the activity data 105 and contextual data 107 can be parsed and analyzed to identify due dates and other timelines with respect to projects or tasks. A module, such as a status generator 106, can analyze the activity data 105 in conjunction with other data such as policy data 107A, machine learning data 107B, calendar data 107C, and external resource data 107D to generate the status data 102 and to identify any users 103 that should receive the status data 102. For example, a number of team meetings, communication transcripts, emails, and channel conversation messages may be analyzed by the system 100 and the system may determine that the activity data 105 and the contextual data 107 has met one or more criteria for one or more users 103. When such a scenario is detected, the status generator 106 generates status data pertaining to particular users and generates user interface data 120 that can cause a display of a user interface 121 comprising a status indicator 123 on a selected display device 122.

The system 100 can also generate a number of sentences that can be used as content of a status indicator 123. In addition, the system 100 can also select sentences and phrases from analyzed content from the activity data 105 to be used as content of a status indicator 123. For instance, a status indicator may have a generated sentence that describes a future event for a particular user, e.g., User 1 is going on vacation in 3 days. In some configurations, the status indicator 123 can also include a duration, e.g., User 1 is going on vacation in 3 days for two weeks.

In some configurations, a status indicator 123 can be generated, selected, or displayed when the activity data and/or contextual data, such as communication data, a shared file, or a specific input, meets one or more criteria. In one illustrative example, a status indicator 123 can be generated when two or more people have a threshold level of collaboration. In such an embodiment, the system may monitor activity data 105 for determining that a collaboration level of a plurality of users exceeds a collaboration threshold. In response to determining that the collaboration level of the plurality of users exceeds the collaboration threshold, the system may cause the display of a status indicator 123. A collaboration level can be determined by a number of different factors. For instance, a collaboration level between a number of different users can be based on a number of documents shared between the users. In another example, the collaboration level can be based on the quantity of data exchange between the users which may include a quantity of video data, a quantity of audio data, etc. A collaboration level can also be based on a number of occurrences of a particular word or phrase shared between users. Thus, when documents or other forms of communication are shared having a threshold number of occurrences of a particular word or phrase, the system may take one or actions such as cause the display of a status indicator 123.

A collaboration level can be based on other factors. For instance, a collaboration level can be based on a frequency of communication sessions between a plurality of users. For instance, if a party has a conversation once a week, that type of collaboration may not trigger one or more actions for generating data defining a status indicator or causing a system to display a status indicator. However, if two particular users meet every day and have a certain quantity of information they share between each other, those two users may have a collaboration level that meets a particular threshold or meets one or more criteria. In another example, a collaboration level can be based on a number of different mediums that may be used between different users. For instance, if a first user and a second user are communicating using a channel application and also contributing to a multiuser editing session of a document, the first user and the second user may have a threshold level of collaboration. In such a determination, the system may take one or more actions described herein based on such criteria. At the same time, if the first user and a third user are only communicating using the channel application, the system may determine that the first user and the third user do not have a threshold level of collaboration. In such a scenario, the system may filter or prevent the display of a status indicator 123.

These examples are provided for illustrative purposes and are not to be construed as limiting. It can be appreciated that the system can determine that a group of users has reached a threshold level of collaboration using any type of user activity. The system can also utilize any combination of factors to determine when a group of users reaches a threshold level of collaboration. In such an example, each factor can be scored individually, and weighted, and in accumulative score may be generated. The system can then display one or more status indicators when the accumulative score reaches or exceeds a collaboration threshold.

In one illustrative example, a status indicator 123 can be generated from shared content based on a priority of a particular topic. For instance, if there are several different sources of activity data, e.g., messages or files, that state: “we need a prototype in three weeks,” and “we are stalled until a prototype is available,” the number of occurrences of a particular word can be used to determine a priority for a keyword, e.g., “prototype,” and the priority can be compared against threshold. If the number of occurrences of a particular keyword exceeds the threshold, the system 100 can determine that particular keyword is a topic, and the system can assign a priority of the topic based on the number of occurrences of the keyword. The system can then generate a number of sentences regarding the topic and an associated deadline or due date. In the current example, it is a given that the word “prototype” occurs a threshold number of times. In response to this determination, the system may determine a due date associated with the topic, e.g., three weeks. The system can then determine if the due date conflicts with one or more events, such as a person's vacation or an extended leave from work. If the due date conflicts with one or more events and/or those events meet one or more conditions, the system may generate a status indicator 123 indicating the due date and/or the scheduling conflict. A generated statement may indicate a user identity associated with the event, a time of the event, and/or a duration of the event. For illustrative purposes, an event may also be referred to herein as a “status change” for a particular user. A status change of a particular user can define a timeline for a person's transition from a work schedule to a vacation, a transition from a working period to a non-working period, etc.

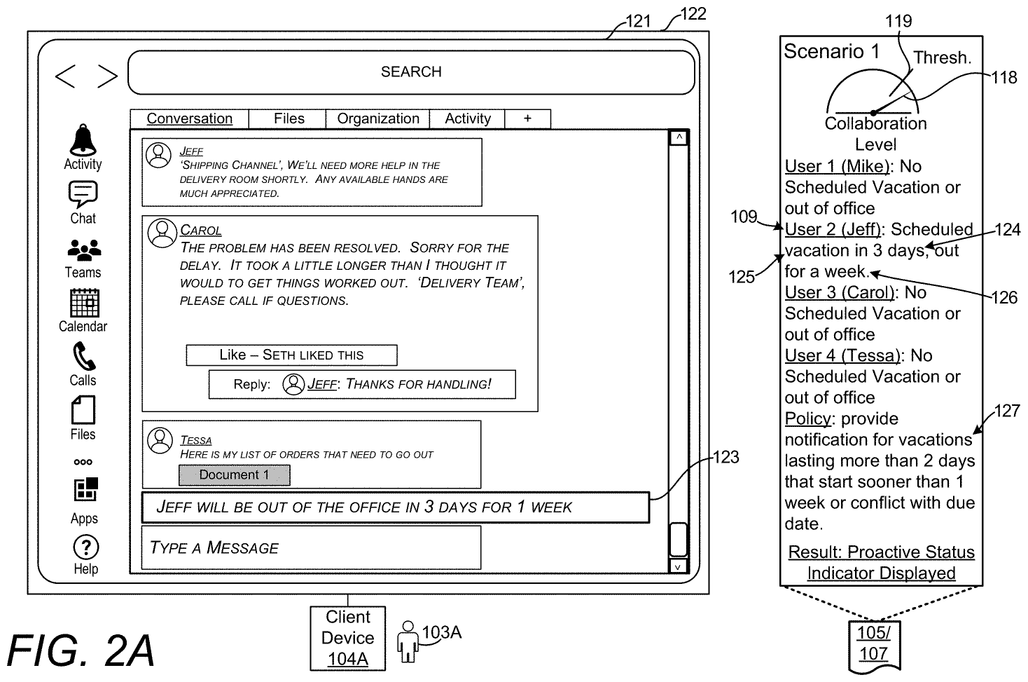

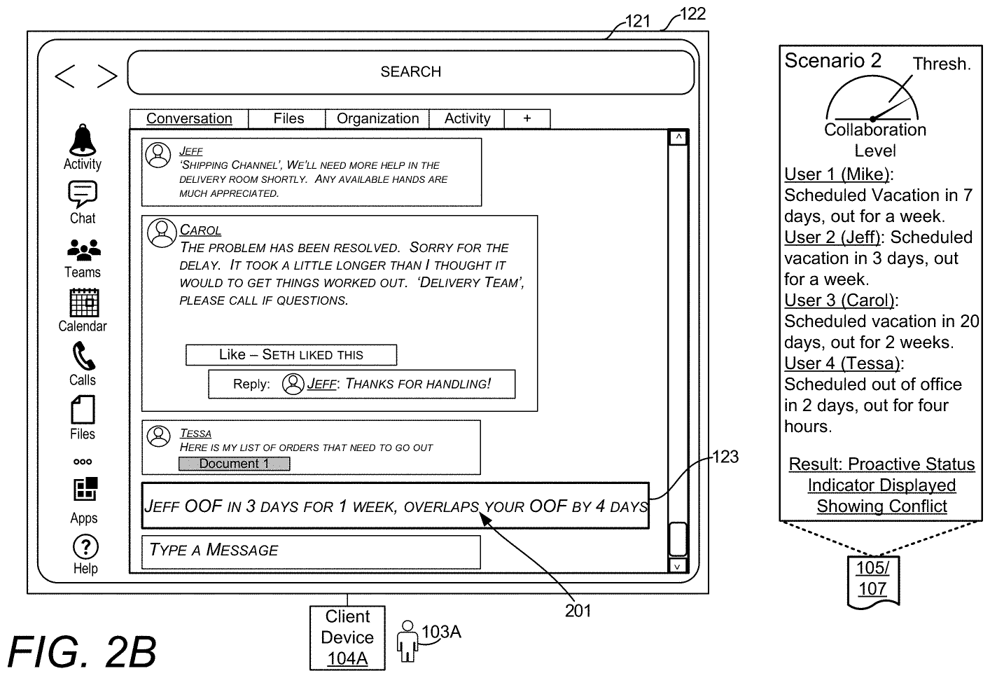

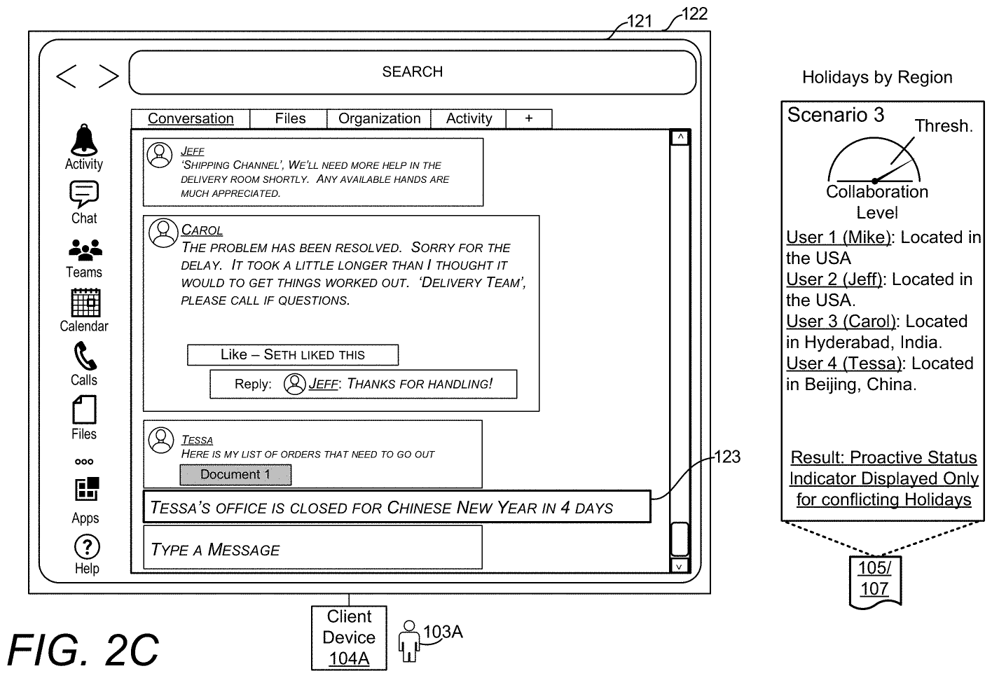

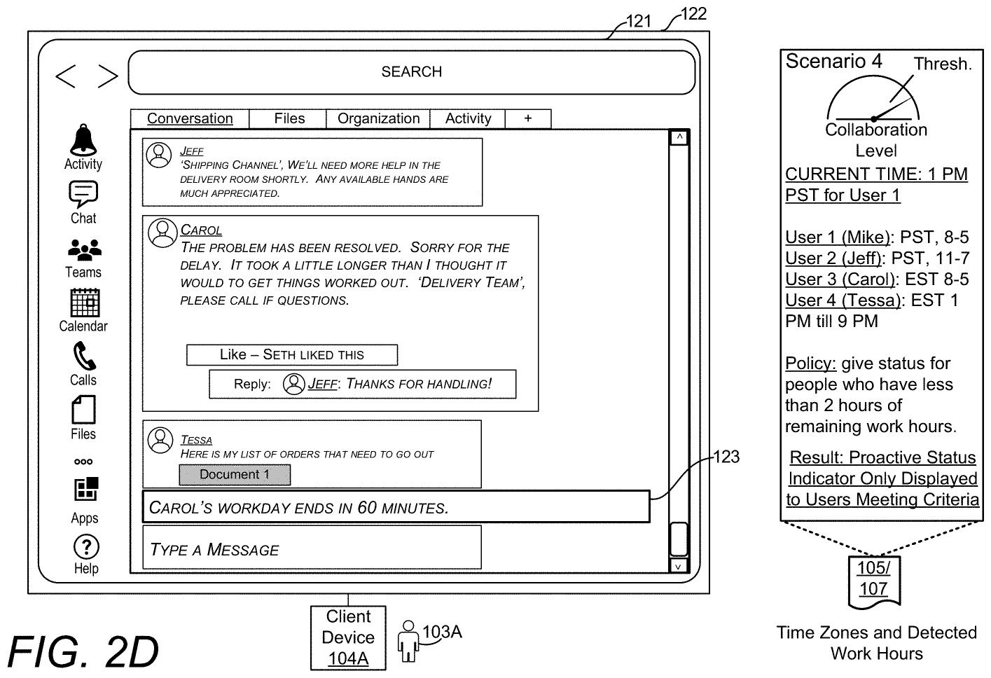

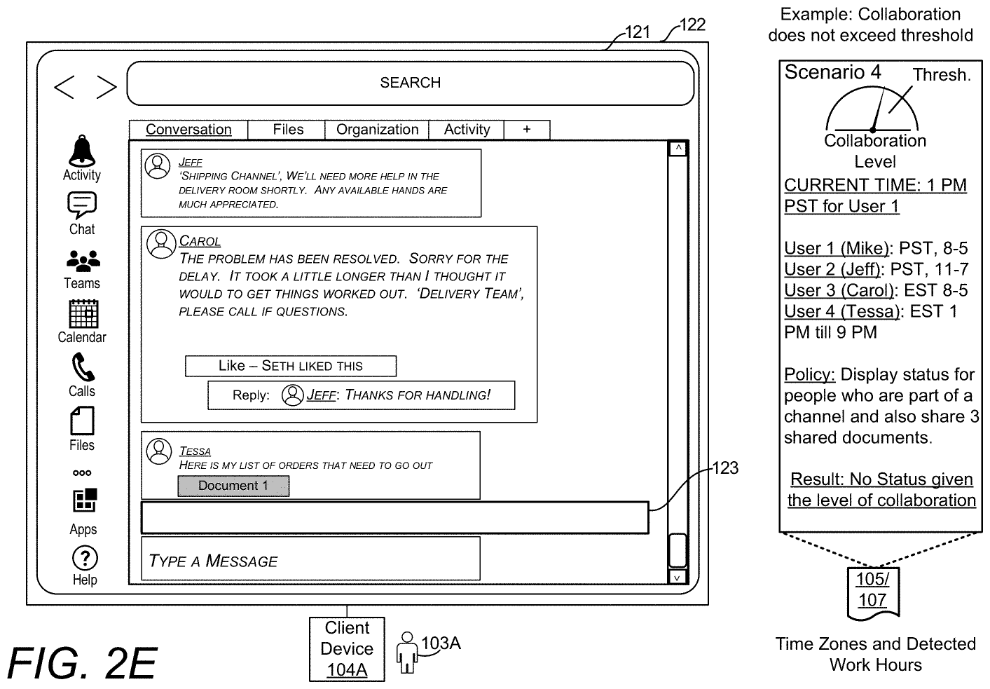

Turning now to FIG. 2A through FIG. 2E, example user interfaces are provided to illustrate different examples of various status indicators 123 that are displayed based on the detection of different scenarios. In particular, FIG. 2A illustrates a scenario where a plurality of users are interacting at a collaboration level 118 that exceeds a collaboration threshold 119. Such a scenario may involve the number of users communicating through a channel such as the example shown in the user interface 121. In this example, the user interface 121 is rendered on a display device 122 of a first computer 104A associated with the first user 103A. The activity data and the contextual data indicates that a second user, Jeff, is scheduled to have a vacation within three days and that the vacation has a duration of a week. A third user 3, Carol, and a fourth user, Tessa, do not have scheduled vacations. Also, in this example, the activity data and the contextual data indicate a policy. The policy can be interpreted by the system 100 such that the system can provide a notification regarding a status that meets one or more criteria, e.g., vacations lasting more than two days and vacations that start within one week of a predetermined time, such as a current time. When the system determines that the analyzed data meets one or more criteria, the system generates and displays a status indicator 123 that states, “Jeff will be out of the office in three days for one week.” In this example, since the vacation for the second user met the conditions of the policy, the system 100 automatically generated the status indicator 123 regarding the second user 103B on a display device 122 of the first computer 104A associated with the first user 103A.

Some configurations can also include a display of one or more conflicts. FIG. 2B, in conjunction with FIG. 1, illustrates an example of such an embodiment. In this example, it is a given that the plurality of users have a collaboration level that meets one or more thresholds. In addition, the system identifies, based on an analysis of the contextual data and the user activity data, that the vacations of two different users conflict with one another. In this example, the system determines an amount of time that the vacations overlap and generates a status indicator 123 showing the amount of time that the vacations overlap in addition to showing a time and a duration of the status change for the second user. The system may display text or another graphical indicator 201 illustrating the conflict or overlap between the two scheduled events.

In some configurations, the system can also identify holidays and other periods of unavailability for certain users based on an analysis of where people are located. FIG. 2C, in conjunction with FIG. 1, illustrates an example of such an embodiment. The system may access one or more resources defining holidays by region. In addition, the system can access one or more resources identifying a location for each user that are interacting at a threshold collaboration level. The system identifies holidays for each user depending on their location. The system can then identify a conflict between those holidays and one or more deadlines identified in the contextual data or the activity data. The system can then display a status indicator when a holiday meets one or more criteria. For instance, a status indicator can be displayed when a particular holiday conflicts with a due date or deadline identified in the contextual data or the activity data, and when the holiday is associated with a location of at least one user. In some configurations, the system may generate a status indicator 123 when the contextual data indicates a deadline that is within a threshold period of the time of a status change, e.g., a date a holiday. In some configurations, the system may generate a status indicator 123 when the contextual data indicates that a date of a status change, e.g., a date a holiday, is within a threshold period of time of a predetermined date, e.g., a current date.

The example shown in FIG. 2C illustrates a user interface having a status indicator 123 that only shows the conflicting holidays. Given the location of each user and the associated holidays for each location, the system only displays a conflict for one holiday for one user, “Tessa's office is closed for Chinese New Year.” In addition to naming the actual holiday that meets one or more criteria, the status indicator 123 also indicates a duration between a current time of the first user 103A and the holiday, e.g., “in four days.”

In such an example, the system may only display holidays that start from a predetermined number of days from a predetermined date, e.g., a current time for the first user 103A. This way, if the holiday was coming up within a week of the current time, the system can conditionally display the status indicator for that holiday. Thus, allowing the system to provide more contextually relevant information. Without having one or more criteria for the display of a holiday, the system may inundate a user with too much information as a channel may involve hundreds or thousands of users.

In some configurations, the system may also identify working hours for particular users and send contextually appropriate status indicators based on the presence of conflicts with respect to one or more working hours. FIG. 2D, in conjunction with FIG. 1, illustrates an example of such an embodiment. In this example, it is a given that the plurality of users are interacting at a collaboration level that meets one or more collaboration thresholds. In addition, the system identifies, based on an analysis of the contextual data and the user activity data, the working schedules for each user. The working hours can be determined by a time zone associated with each user. Thus, for each time zone, set of hours, e.g., 8 AM to 5 PM, can be applied for each user as a default. In addition, certain users can provide preferred working hours for storage in one or more resources, such as a calendar database. In this example, the first user 103A works from 8 to 5 Pacific standard Time, the second user 103B works from 11 to 7 Pacific standard Time, the third user 103C works from 8 to 5 Eastern standard Time, and a fourth user 103D works from 1 PM to 9 PM Eastern standard Time. In addition, it is given that the contextual data defines a policy, e.g., that a status should be given for users having less than two hours remaining within a workday. Thus, in this example, if the first user 103A is interacting with the client device 104A at 1 PM Pacific standard Time, the system can determine that a work schedule for at least one user, the third user 103C (Carol), meets the conditions of the policy. Thus, the system displays a status indicator 123 describing that “Carol's workday ends in 60 minutes.” As shown, the system can identify user that has a work schedule meeting the criteria but the system also displays the remaining time left within their workday.

The system controls the display of each status indicator 123 such that the other work schedules are not displayed if they do not meet the one or more criteria. Without having one or more criteria related to the work schedules, the system may inundate a user with too much information as a channel may involve hundreds or thousands of users.

The system can also control the display of status indicators based on the level of collaboration. FIG. 2E, in conjunction with FIG. 1, illustrates an example of such an embodiment. In this example, the activity of the of users 103 does not meet the threshold collaboration level. This may occur when the contextual data and the activity data indicate that a plurality of users are only interacting using a single channel, and a policy requires a higher level of collaboration. In the example shown in FIG. 2E, the policy defines criteria where the users are operating a threshold level of collaboration if a group of people are at least part of a channel and also collaborate in at least three multi-user document editing sessions. In this example, since the users do not meet the threshold, the system does not display a status indicator 123. Alternatively, when the threshold level of collaboration is not met, the system may provide redacted status indicators, e.g., a status indicator only showing names of users having a conflict, etc. A similar result may occur when the parameters of a status, such as a time, duration or type of status does not satisfy one or more criteria. For instance, if a policy indicates that a particular person or a group of people do not prefer to receive status indicators showing that a user is unavailable due to a meeting but they do prefer to receive status indicators showing that a user is unavailable due to vacations and holidays, the system would not display a status indicators for a meeting that causes a scheduling conflict, but the system would display a status indicator for a vacation or holiday that causes a scheduling conflict.

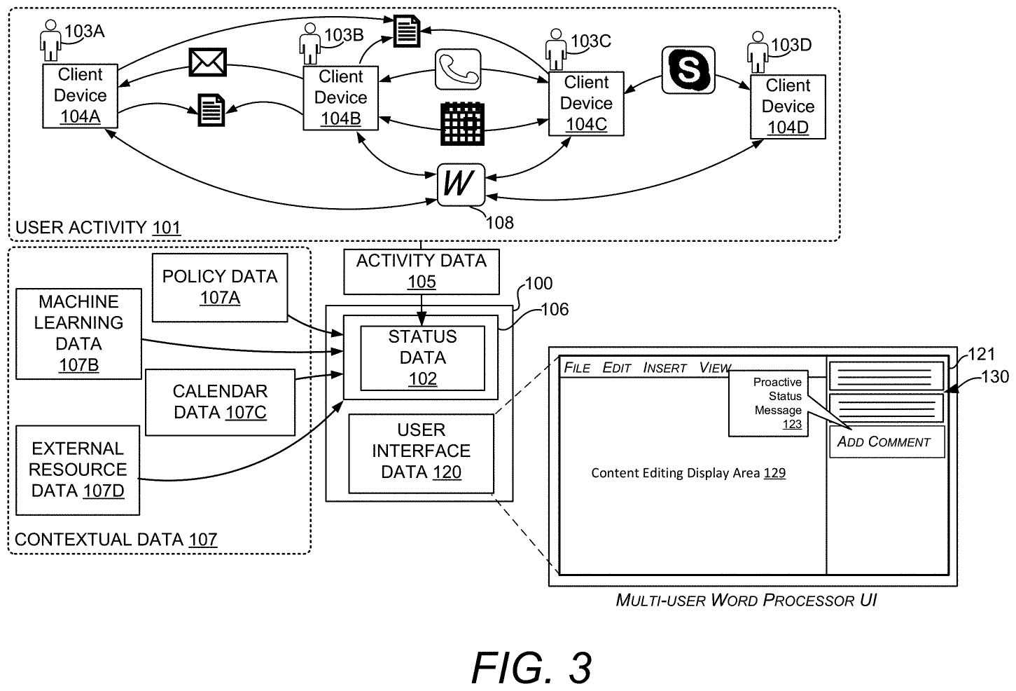

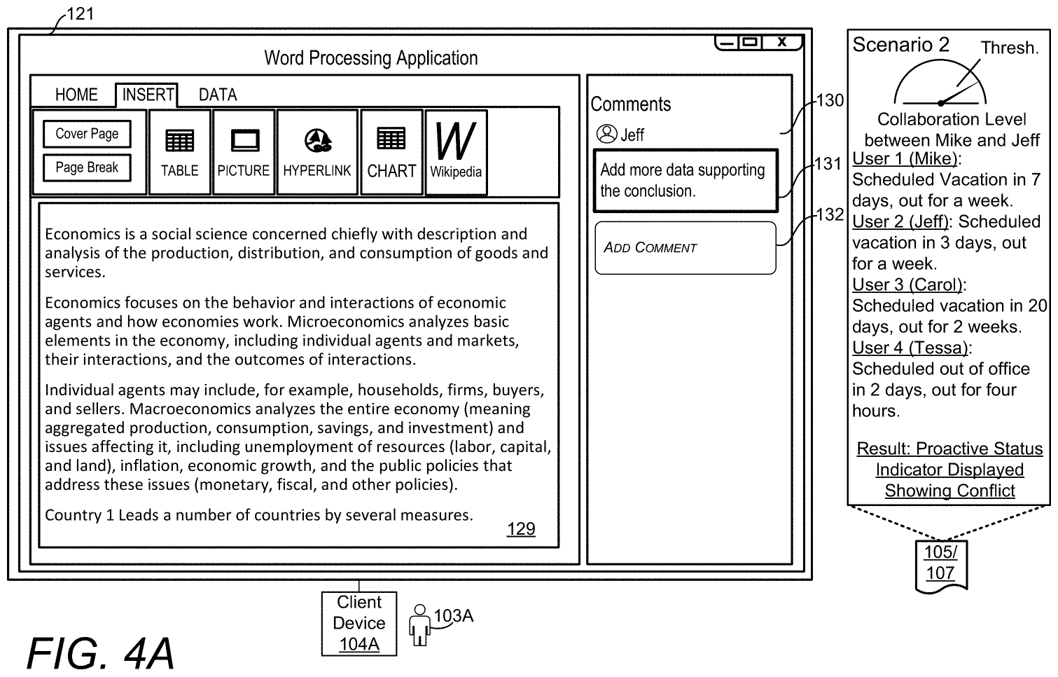

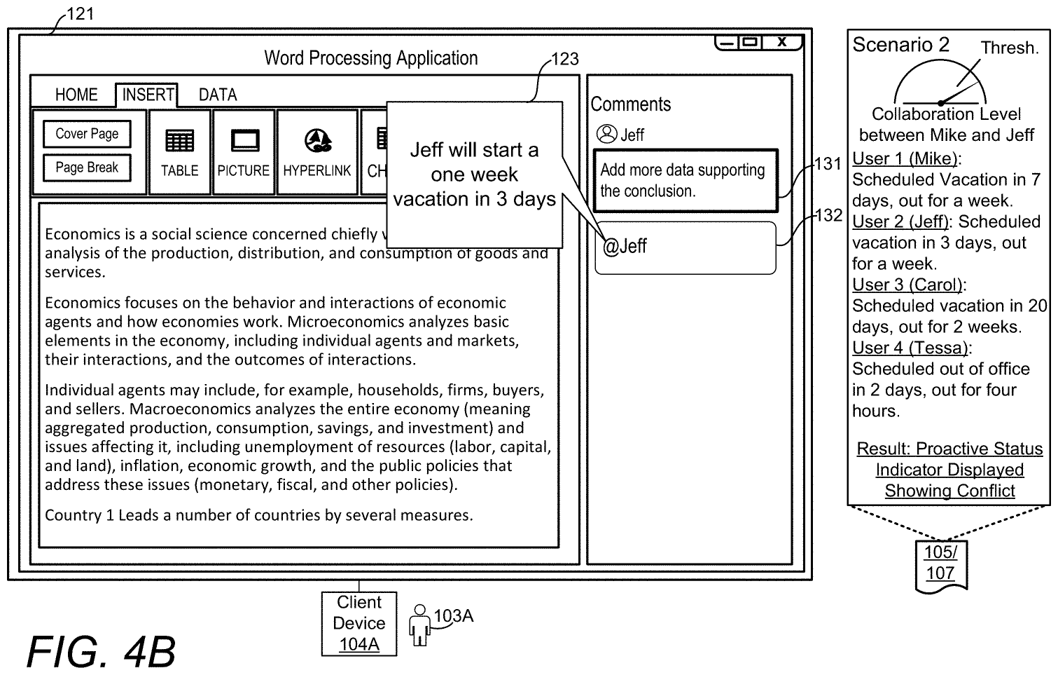

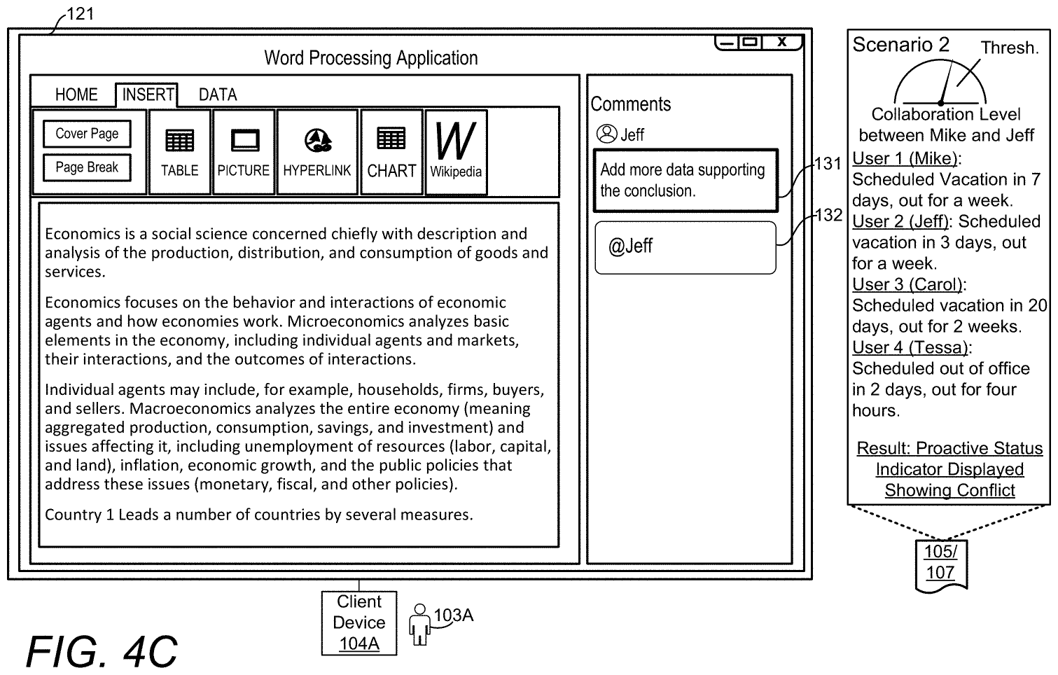

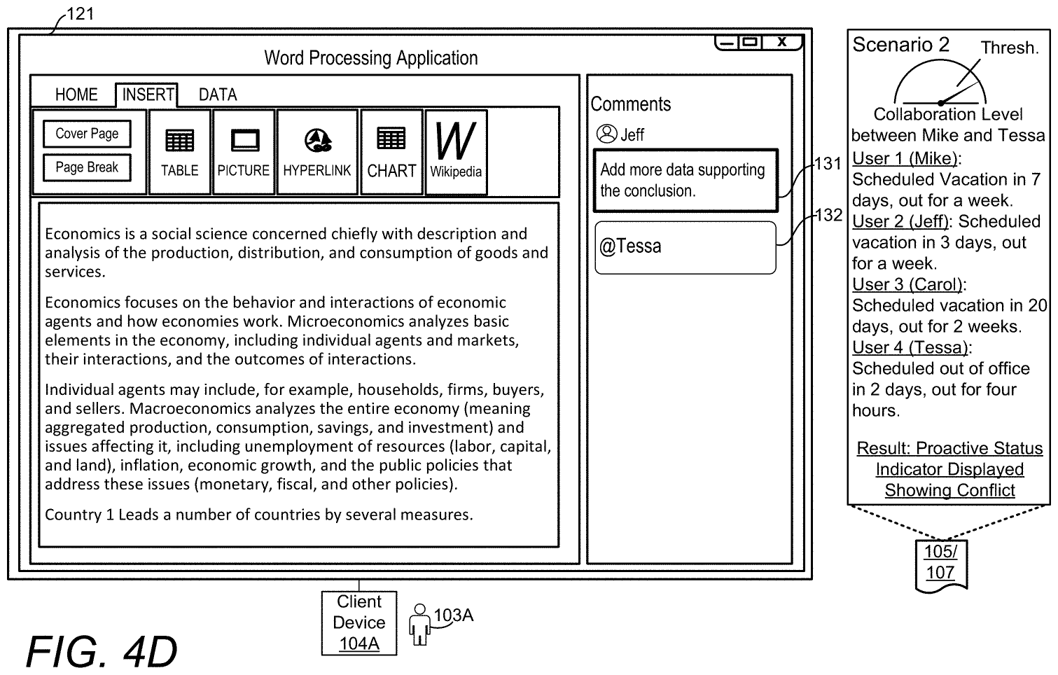

FIG. 3 illustrates another example scenario involving a multiuser editing system 108 for illustrating aspects of the present disclosure. In this example, the system 100 can analyze contextual data and the activity data to determine when a status indicator 123 is displayed. The system 100 can cause the display of a status indicator 123 in association with a user interface 121 having a content editing display area 129 and a comment section 130. As shown in FIG. 4A, a user, such as the first user 103A, can view a comment 131 and provide a response in a comment field 132. Similar to the embodiments described herein, the system can provide a status indicator in response to the content shown in the content editing display area 129, the content in the comment section 130, or any other contextual data or activity data. In addition, as shown in FIG. 4B through FIG. 4D, the system can display a status indicator in response to one or more inputs provided by a user, such as the first user 103A.

As shown in FIG. 4B, when the first user 103A provides an input that identifies a particular user, such as the second user 103B (Jeff), the system can retrieve calendar data and other contextual data regarding identified user, second user 103B. If the contextual data regarding the identified user meets one or more criteria, the system can display the status indicator 123 regarding the identified user. In this example, the system receives a policy indicating that vacations lasting more than five days, that also start within a week, are to be displayed in a status indicator. The system can analyze the policy with the schedule of the identified user. Thus, given the criteria established in the policy, the system will display a status indicator 123 stating Jeff's vacation schedule. In some embodiments, the system cannot only indicate the timeline for the vacation, the system can provide a quantity with respect to the remaining time, e.g., 3 days, before the vacation starts. The status indicator can also provide the duration of the vacation. By providing this combination of data, the user, such as the first user 103A, can adjust their comment quickly before they actually provide the contents of the comment to the system. This can save substantial computing resources by mitigating the need for the user to look up each person's calendar information and/or having to create chat content to identify future schedule conflicts. This example is provided for illustrative purposes and is not to be construed as limiting. It can be appreciated that the system can operate from any policy that defines one or more criteria. In other embodiments, the criteria can be based on any type of deadline that is identified in the content of the document or the thread. If any discovery deadline is within a certain threshold of any other scheduled status change of a particular user, one or more status indicators indicating the status change can be displayed.

The system can control the display of the status indicator 123 based on a collaboration level between one or more users. In the example shown in FIG. 4B, it is a given that the collaboration level between Mike and Jeff exceed a threshold. This scenario may be detected when two or more users have a certain level of collaboration with respect to chat sessions, multi-user editing sessions, etc. A threshold level of collaboration can include a threshold number of shared chat sessions, documents, or other factors described herein. In this example, in response to receiving an input identifying a user, such as the second user 103B, the system may determine if the identified user has a threshold collaboration level with user providing the input. If the system determines that the identified user has a threshold level of collaboration with the user providing input, the system may analyze the schedule of identified user the with respect to a policy and display a status indicator if the schedule meets the one or more criteria. As shown in the example of FIG. 4C, when the system detects that the level of collaboration between the user providing the input (Mike) and a user identified in the input (Jeff) falls below a threshold, the system may filter, or prevent, the display of a status indicator 123.

The example of FIG. 4D illustrates another input provided by the first user 103A. In this example, the input identifies the fourth user 103D (Tessa). In response to this input, the system analyzes the schedule with respect to the fourth user 103D and determines if the schedule meets one or more criteria, such as the criteria defined in the above-described policy. In this example, the schedule for the fourth user 103D does not meet the criteria since Tessa is only scheduled to be out of the office for four hours. Given this scenario, the system does not display a status indicator. Such a result may occur even if the first user and the fourth user have a threshold level of collaboration. Thus, in some embodiments, the system may display a status indicator when a user providing an input has a threshold level of collaboration with user identified in the input, and when a status change associated with the identified user meets one or more criteria.

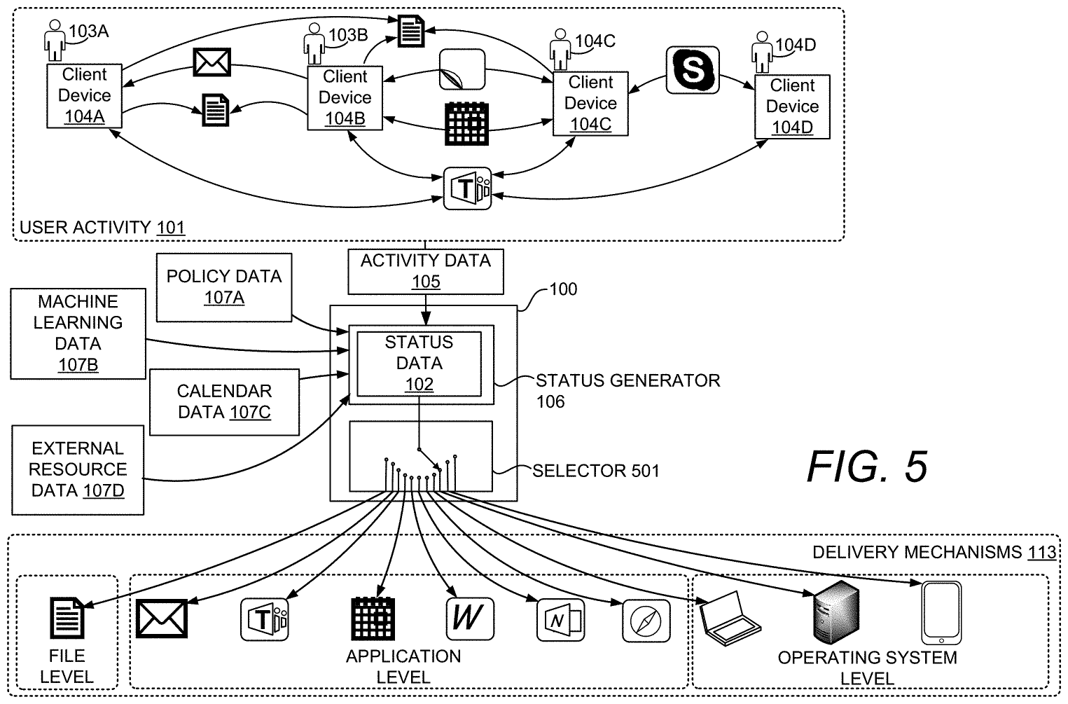

To optimize the efficacy of the status indicators 123, the system 100 may select a delivery mechanism for individual status indicators 123. FIG. 5 illustrates an example of this embodiment. As shown, the system 100 may include a selector 501 for identifying a delivery mechanism 113. The delivery mechanisms 113 can include any system, platform, file, application, service, or any other computerized mechanism for communicating and displaying a status indicator. Depending on when a person interacts with a computer, the type of interactions they have with a computer, the applications they may use, and the files they interact with, a status indicator may be delivered to any combination of delivery mechanisms 113. For instance, a status indicator 123 may be embedded into a file, sent via text, sent via email, posted on a channel, delivered using an in-application (“in-app”) message, delivered using an operating system notification feature, etc. As will be described in more detail below, a status indicator 123 may be configured to cause an application to display a status indicator, e.g., provide notifications of an associated deadline, provide a notice of a deadline with respect to a status change associated with a user, etc.

One or more delivery mechanisms 113 can be selected based on the preference data 107A, the machine learning data 107B, calendar data 107C, and other external resource data 107C. For example, if the preference data and the machine learning data indicate that a user spends more time using a word processing application rather than a calendaring application, a status indicator 123 intended for that user may be sent directly to the word processing application for the display in an in-app message. In addition, or alternatively, if a user is working with a particular file but utilizes a number of different applications to access that file, a status indicator 123 may be embedded within that file so that the status indicator 123 may be displayed regardless of the application that is utilized to access the file.

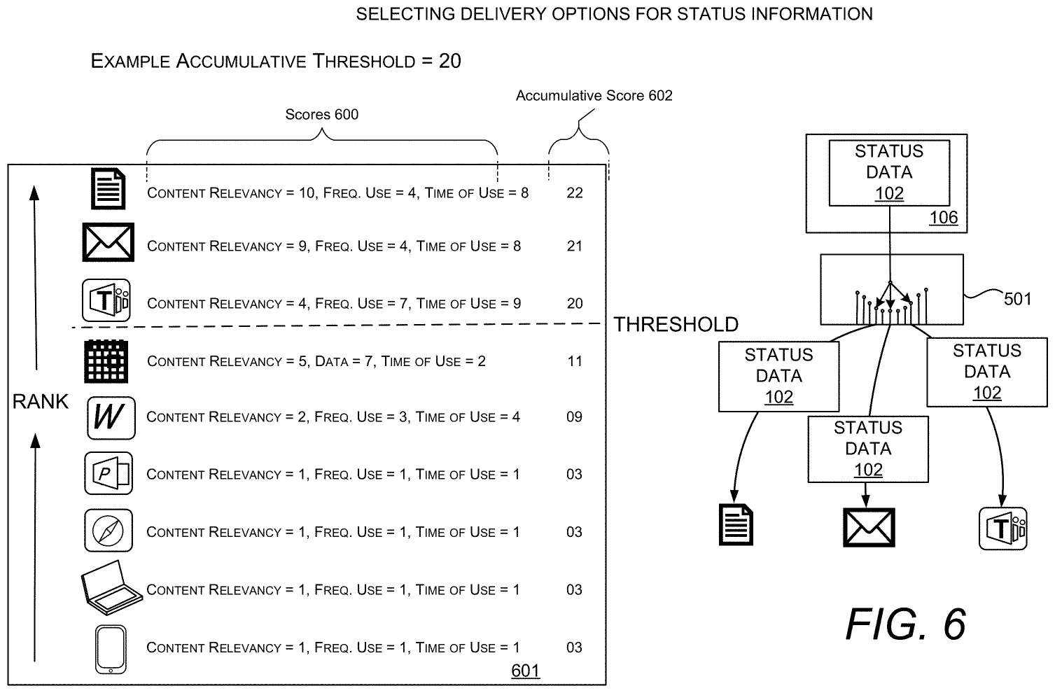

FIG. 6 illustrates an example showing how the selector 501 utilizes a number of factors to select one or more delivery mechanisms 113 for one or more status indicators 123. Generally described, each factor can be scored according to a level of interaction with a user. The scores can be based on any suitable scale. In one example, scores associated with individual factors such content relevancy, use frequency, and time of use of individual delivery mechanisms 113, can be analyzed to select a delivery mechanism 113 for a status indicator 123. In such embodiments, contextual data and/or activity data, including machine learning data, that may be monitored over time. The use frequency can indicate a number of times that a particular user accesses or uses a delivery mechanism, e.g., a file or an application, over a period of time. For instance, if a spreadsheet application is used more frequently than a word processing application, the spreadsheet application may have a higher score than the word processing application. The relevancy can be based on the content of files or the content of files accessed by an application.

Another factor involving usage data can indicate a level of interaction a user may have with an application or file. For instance, if a user edits a first word document causing 5 KB of edits and then edits a second word document causing 200 MB of edits, the first word document may have a higher score than the second word document. Usage data can also apply to applications, for instance, if a user edits a collection of documents through an application, a data usage score can be generated for such an application.

The “time of use” can indicate how a particular file or application may be scored. For instance, if a user utilizes a word processing application during work hours and uses an online spreadsheet preprogram outside of working hours, the word processing program may score higher than the spreadsheet program. In another example, if a user accesses a word processing application on the weekends and a spreadsheet application during the weekdays, the spreadsheet application we have a higher score than the word processing application.

In example shown in FIG. 6, the scores 600 for each delivery mechanism 113 are processed to generate an accumulative score 602. Although this example illustrates that each score is summed to create the accumulative score, it can be appreciated that any type of algorithm can be utilized to generate the accumulative score 602 based on the individual scores 600. In this example, the accumulative score 602 is compared to a threshold and the delivery mechanisms 113 that exceed the threshold are selected. If the system 100 determines that the selected mechanisms are not being used, the system 100 can rank a list and deliver status indicator 123 to various mechanisms 113 depending on the rank.

The data illustrated in the table of FIG. 6, is referred to herein as analytics data. Such data can be displayed to a user in a graphical user interface 601, thus allowing a user to understand how different delivery mechanisms are selected. By displaying such information, a user can understand how decisions are made within the system 100. In addition, the user can make one or more adjustments by selecting different factors, or by changing a weight that is applied to a factor, or allowing a user to make a manual selection. For instance, a user can select a particular delivery mechanism or change the ranking of the displayed delivery mechanisms. If a user selects a particular factor within the table shown in FIG. 6, the user can remove a specific factor, such as the “time of use” factor. In response to such an input, a system can re-rank the delivery mechanisms and/or select a different set of delivery mechanisms using factors without considering the removed factors, e.g., the “time of use” factor.

In some configurations, the system 100 can utilize a delivery schedule with the selection of specific delivery mechanisms 113. Thus, a status indicator 123 can be delivered to a user at the right place at the right time, which may include a series of coordinated actions or messages for the purposes of increasing the usefulness and efficacy of the delivery of the status indicator 123.

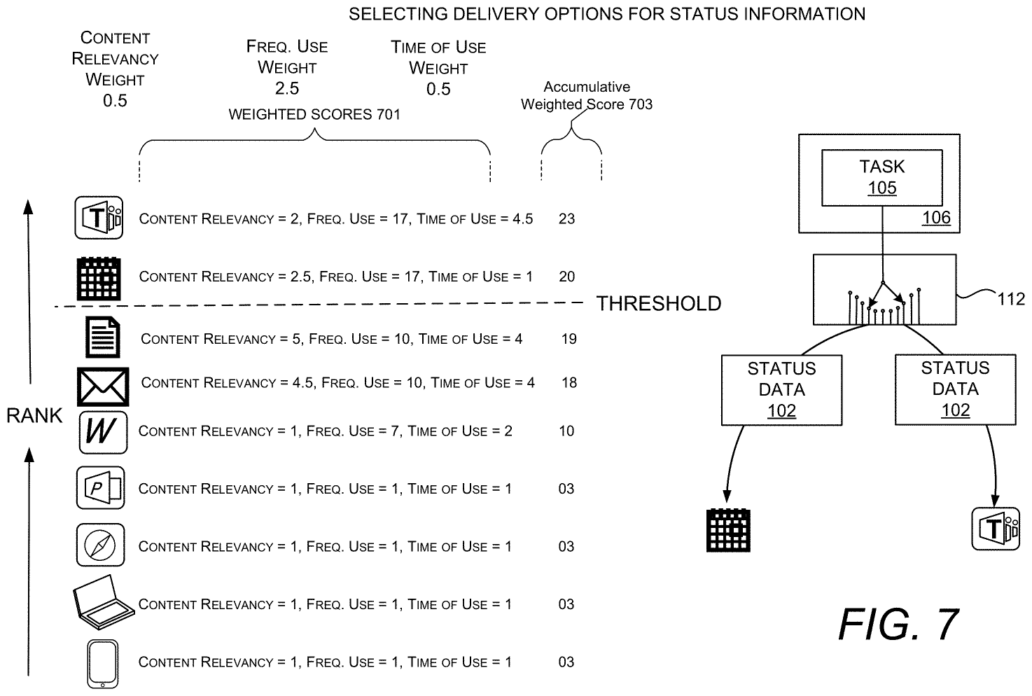

In some configurations, the scores for each delivery mechanism 103 can be normalized or weighted. FIG. 7 illustrates an example of such an embodiment. In this example, a number of weights are applied to each score to generate a weighted score 701. The weighted scores are used to generate an accumulative weighted score 703. The weights that are applied to each score can be based on a number of resources including but not limited to contextual data, such as user preference data, machine learning data, or activity data.

In one illustrative example, if the system 100 determines that a recipient of a status indicator 123 is not using an application that is selected to deliver the status indicator 123, or does not open a file that has an embedded status indicator 123, the system may reduce any score that was used to select that delivery mechanism 113. For instance, the examples shown in FIG. 6 and FIG. 7, the use frequency weight and the time of use weight may reduce the related scores of the email application if the system 100 determines that the user is not reading or utilizing that delivery option. As shown in the figures, the email system is selected as a delivery mechanism in FIG. 6 but is later removed as an option in FIG. 7. This may result in the system 100 determining that a particular system, such as the email system, is not being utilized or is not effective for delivering a status indicator 123.

The weights that are applied to different factors can come from a number of different resources. For instance, the weights can be generated by a machine learning system that can measure how much a particular delivery mechanism is being used. Thus, if the machine learning system determines that a particular delivery mechanism, such as an email application, is often selected but not actually used by a person, the system can eliminate the factors that are used to select such a delivery mechanism or the system can apply a particular weight, e.g., less than 1, to such factors. In another example, the weights that are applied to different factors can come from a user input. This enables a user to make real-time adjustments to the decision-making process after looking at the analytics and enabling them to understand how a delivery mechanism is selected.

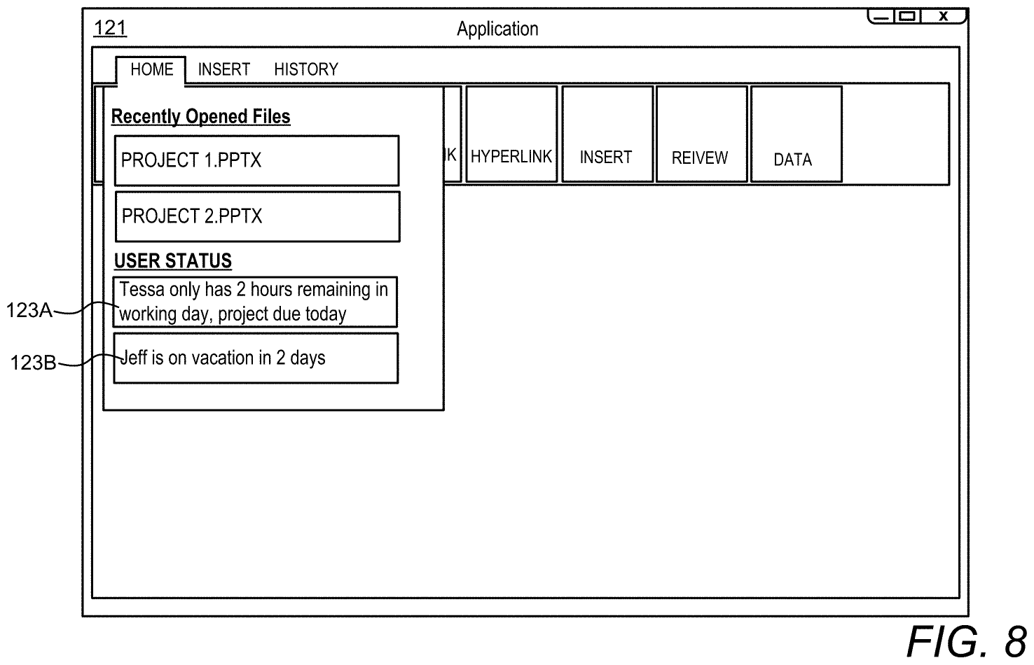

As summarized above, the delivery mechanisms can involve a number of different types of user interfaces, applications, and other forms of data that can communicate a status indicator 123. FIG. 8 illustrates an of example user interface that can be utilized with the techniques disclosed herein. Specifically, FIG. 8 illustrates an example user interface having a first status indicator 123A and a second status indicator 123B configured in a commonly used drop-down menu. In this case, when a user attempts to open a file, they are reminded of his status of a particular user at that time.

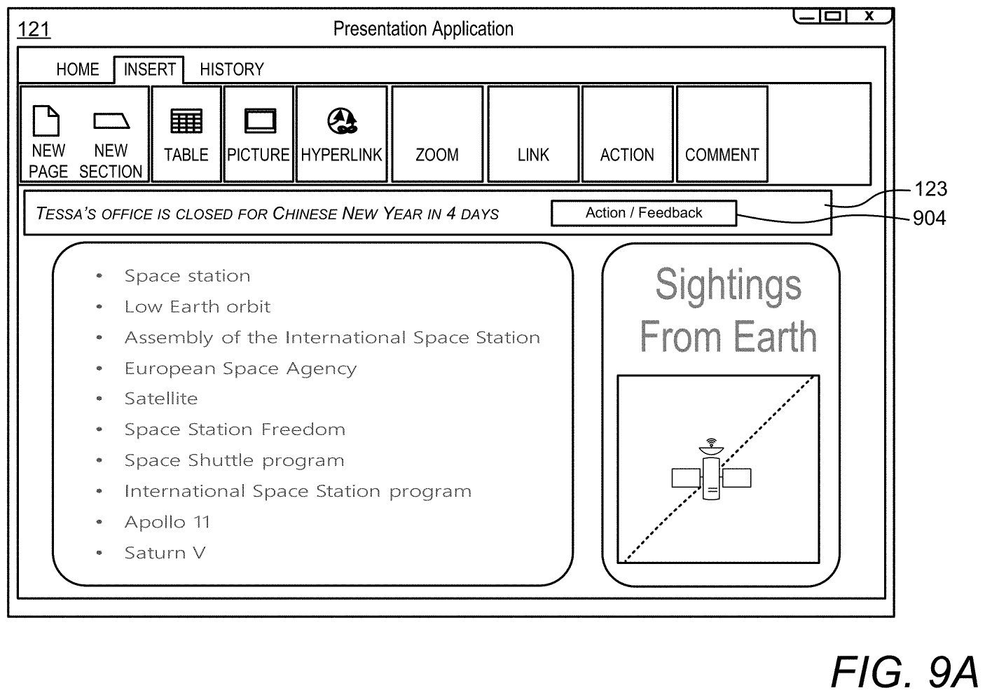

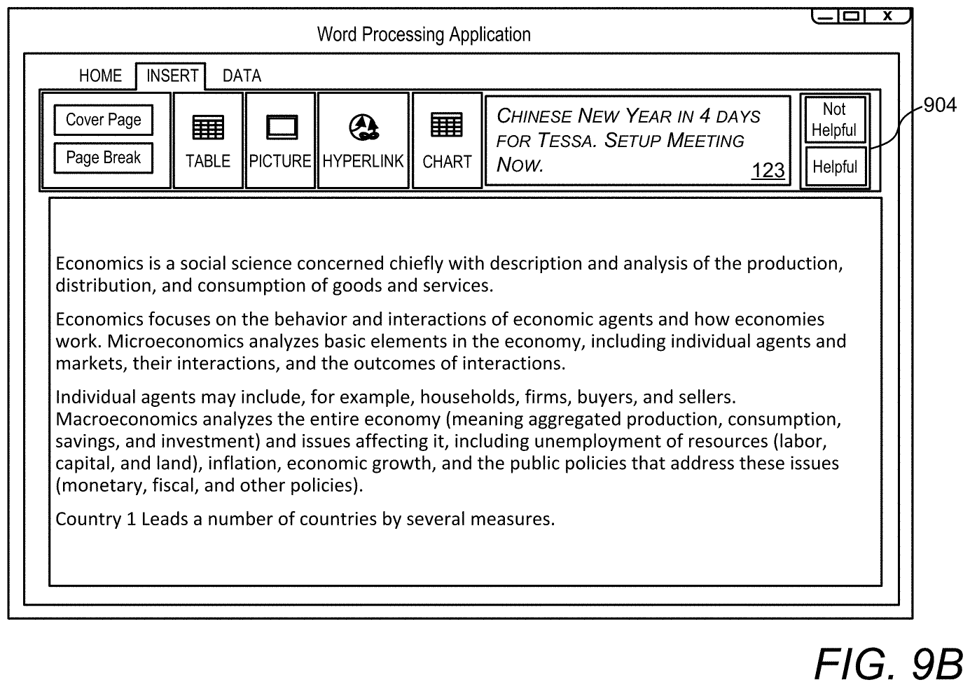

FIG. 9A illustrates an example of how a user interface 121 of an application can be modified to convey a status indicator 123 to a recipient using an in-app message. In this example, the status indicator 123 is displayed at a location that is in close proximity, e.g., adjacent, to the content the recipient is working on. In some configurations, the in-app message can also include a graphical element 904 that can allow a user to provide feedback regarding the status indicator. Thus, if the user finds the status indicator to be useful or not useful, user can indicate that by a voice command or by one or more interactions with the graphical element 904. The feedback can be utilized to change one or more policies regarding how a status indicator is displayed to that user. The feedback can also be used to update machine learning data to more accurately select a delivery mechanism for status indicator. The graphical element 904 can also be configured to navigate a user to functionality that allows them to follow up to the status indicator 123. For example, the graphical element 904 can help a user navigate to a meeting or a chat room to resolve the issue indicated in the status indicator 123.

FIG. 9B illustrates another example of how a status indicator 123 can be delivered to a recipient using an in-app message. Such a status indicator can be displayed automatically to user based on the time of day, and relevancy of the content they are working on with respect to a person's status change, or an input provided by the user. This example also illustrates another configuration of a graphical element 904 that can receive positive or negative feedback regarding a status indicator 123. As described herein, positive or negative feedback regarding the status indicator can modify one or more criteria that is used to control the display of future status indicators. The feedback can also be used to select a delivery mechanism 113.

In this example, the system also provides a more complex status indicator that provides a recommendation for an action. In this example, the system 100 can analyze the schedules of one or more users, such as the first user receiving the status indicator 123 and the subject of the status indicator. The system can then identify one or more timeslots that are available for both users and make a recommendation about a meeting time based on those available timeslots.

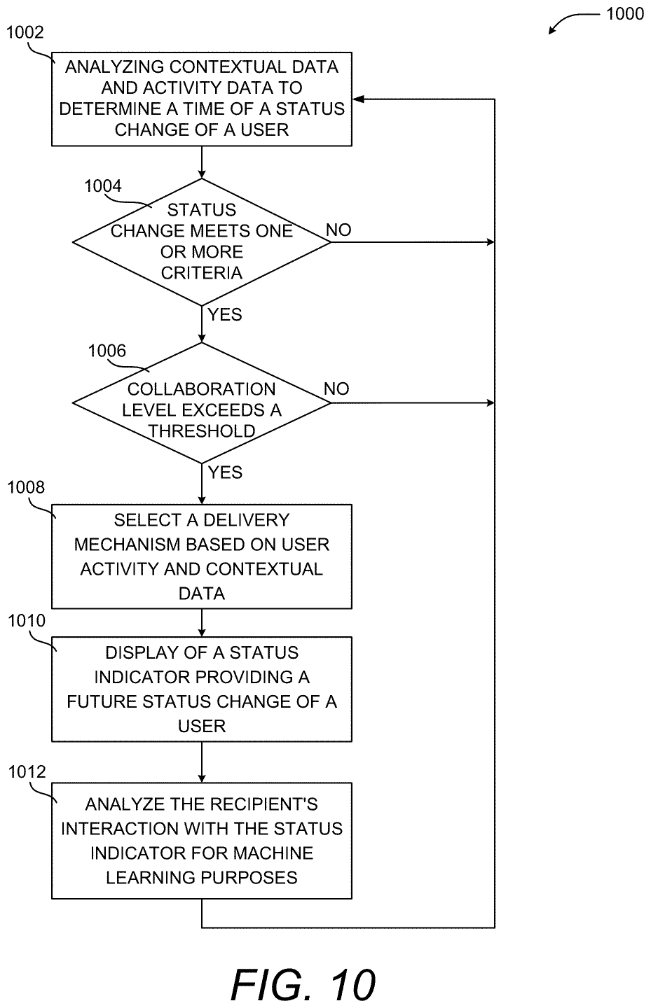

FIG. 10 is a diagram illustrating aspects of a routine 1000 for computationally efficient generation and management of status indicators 123. It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It should also be understood that the illustrated methods can end at any time and need not be performed in their entireties. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system such as those described herein) and/or (2) as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof.

Additionally, the operations illustrated in FIG. 10 and the other FIGURES can be implemented in association with the example presentation UIs described above. For instance, the various device(s) and/or module(s) described herein can generate, transmit, receive, and/or display data associated with content of a communication session (e.g., live content, broadcasted event, recorded content, etc.) and/or a presentation UI that includes renderings of one or more participants of remote computing devices, avatars, channels, chat sessions, video streams, images, virtual objects, and/or applications associated with a communication session.

The routine 1000 starts at operation 1002, where the system 100 analyzes contextual data and activity data to determine a time of a status of a user. In some configurations the contextual data can include activity data, such as communication data. A status of user can include any type of appointment, state, or modification (a “status change”) to a person's availability. For instance, a person's status may change at a time when they transition from a working hour to a nonworking hour. A status change may include the start of a vacation, a day off, or otherwise transition from an “available” status to an “unavailable” status. The system can determine a status of a person by the use of a number of different types of contextual data and activity data. For instance, a computer can analyze calendar data to determine when a person is available or unavailable. The calendar data can include a time of a status, a duration of the status, and a status type. In addition, the system can analyze communication data, such as a person's emails or chat messages, to determine when a person stated they are going to be unavailable. The system can analyze any type of contextual data or activity data to determine a time and/or date when a status change will begin and when a particular status will end.

The routine 1000 proceeds to operation 1004, where the system 100 determines if the status change meets one or more criteria. The system can utilize different types of contextual data and activity data to determine if a status change meets one or more criteria. For instance, a particular status, such as an “out of office” status, can meet one or more criteria when the duration of the status exceeds a minimum time threshold. This allows the system to filter status messages. For instance, if a person's calendar indicates they are only to be out of the office for half a day, such status changes may not trigger the generation or display of a status indicator 123.

In another example, a status indicator 123 may only be displayed when a status change is starting within a certain period of time from a predetermine time, such as a current time. Such features filter certain status changes from being displayed. For instance, if a person has a vacation starting in two months, such a status change may not be displayed, particularly if a system policy indicates that status changes starting within a certain time, e.g. two days, a week, etc., are of interest. Thus, in some embodiments, a status change meets one or more criteria when the contextual data indicates that the time of the status change is within a threshold period of the time with respect to a current time, wherein the status indicator further indicates a duration between the current time and the time of the status change.

In yet another example, a status indicator may only be displayed when activity data, including voice communications or text communications, indicates a deadline that is within a threshold period of the time of the status change. For instance, if an email indicates that a particular project is due at the last day of the month, and it turns out that a particular person's vacation starts within a threshold period of time, e.g. three or four days, from that due date, the system may cause a display of a status indicator. In such an embodiment, the status indicator may describe a duration between a predetermined time, such as a current time, and the time of the status change.

The system can also identify conflicts between two different schedules. For instance, a system can determine when two vacations overlap with one another. When such a scenario is detected, the system can display a status indicator describing each status change, e.g., the timeline of vacations for two different users. In addition, the system can also describe the amount of overlap between the two timelines of each status change. For instance, a system may indicate that two users have overlapping vacations and the system may indicate the number of days that the two vacations overlap.

The system can also analyze contextual data and activity data describing working hours for different individuals, time zones associated with individuals, or holidays associated with different individuals. The system can then control the display of each status indicator based on these factors. For example, a system can receive data indicating a timeline for a status change, e.g., a timeline for an “out of office” status having a start time and an end time. The system can then determine that a status change meets one or more criteria when the start time or the end time is within a threshold period of the time of a predetermine time, such as a current time of a particular user. The status indicator can also provide a time duration between the current time and the end time of the status change, or a time duration between the current time and the start time of the status change.

The system can also determine that a status change meets one or more criteria when a user input identifies a person associated with the status change. For instance, in a channel or chat program, a user may type the name of a particular person. In response to such an input, the system may identify a status change for that particular person and display details about that person status change.

Next, at operation 1006, the system 100 can determine if two or more people have a threshold level of collaboration. This feature allows the system to filter the display of status indicators, and only display status indicators for two or more people have a threshold level of collaboration. In some configurations, a system may monitor activity data 105 for determining that a collaboration level of a plurality of users exceeds a collaboration threshold. In response to determining that the collaboration level of the plurality of users exceeds the collaboration threshold, the system may cause the display of a status indicator 123. A collaboration level can be determined by a number of different factors. For instance, a collaboration level between a number of different users can be based on a number of documents shared between the users. In another example, the collaboration level can be based on the quantity of data exchange between the users which may include a quantity of video data, a quantity of audio data, etc. A collaboration level can also be based on a number of occurrences of a particular word or phrase shared between users. Thus, when documents or other forms of communication are shared having a threshold number of occurrences of a particular word or phrase, the system may take one or actions, such as, cause the display of a status indicator 123.

A collaboration level can be based on other factors. For instance, a collaboration level can be based on a frequency of communication sessions between a plurality of users. For instance, if a party has a conversation once a week, that type of collaboration may not trigger one or more actions for generating data defining a status indicator or causing a system to display a status indicator. However, if two particular users meet every day and have a certain quantity of information they share between each other, those two users may have a collaboration level that meets a particular threshold or meets one or more criteria. In another example, a collaboration level can be based on a number of different mediums that may be used between different users. For instance, if a first user and a second user are communicating using a channel application and also contributing to a multiuser editing session of a document, the first user and the second user may have a threshold level of collaboration. In such a determination, the system may take one or more actions described herein. At the same time, if the first user and a third user are only communicating using the channel application, the system may determine that the first user and the third user do not have a threshold level of collaboration. In such a scenario, the system may filter or prevent the display of a status indicator 123.

Next, at operation 1008, the system 100 can select a delivery mechanism 113 for the status indicator 123. As described herein, one or more factors can be utilized to determine the appropriate delivery mechanism 113. The factors can be based on, but not limited to, machine learning data, activity data, preferences, and contextual data. The contextual data can be received from external resources such as address books, social networks, calendar systems, etc. A delivery mechanism 113 can be a file, application, or any other computer-controlled module influencing content displayed on a user interface. Any number of factors may be utilized to select a delivery mechanism 113 including those factors illustrated in the examples described herein an association with FIG. 6 and FIG. 7.

Next, at operation 1010, the system 100 can cause the display of a status indicator 123. The status indicator 123 can be displayed in response to one or more criteria including, but not limited to, criteria relating to the time and/or duration of a status change for a particular user, criteria relating to a threshold level of collaboration, and criteria relating to a user input. For example, the status indicator 123 can be displayed within a user interface of a communication application in response to a user input identifying a particular person. In other examples, as described above in association with FIGS. 5-7, a status indicator 123 can be displayed within a user interface of any application or file that is selected based on an analysis of user activity data. The delivery mechanism can include any suitable platform, software application, or file, that is selected based on the user's interaction with a computer.

Next, at operation 1012, the system can analyze the user activity of a person receiving a generated status indicator 123 for the purposes of collecting and analyzing machine learning data. For instance, when a particular user receives a status indicator 123, and that user does not take action based on the status indicator 123, the system 100 can analyze that type of activity and make real-time adjustments to ensure that the user receives the notification of the status indicator 123. For instance, if the system determines that a user did not respond to the status indicator 123, the system may select another delivery mechanism 113 and display the status indicator 123 in a user interface of another application or embed the status indicator 123 in a file.

At the same time, the system 100 may also measure a level of activity with respect to a user's interaction with the status indicator 123. This data can be collected and utilized for selecting delivery mechanisms 113 for future status indicators 123. For instance, if a person responds with one or more user activities after a display of a status indicators 123, the system can update scores, such as those shown in FIG. 6 and FIG. 7, and other metrics that may be used to select a delivery mechanism for future status indicators 123. In this example, if a user makes any measurable action with a status indicator 123 of a particular delivery mechanism 113, that particular delivery mechanism 113 may be scored higher than other delivery mechanisms that did not produce the same measurable action. In operation 1012, the system 100 can also communicate the data defining the user interaction with a machine learning service. Different metrics, examples of which are shown in FIG. 6 and FIG. 7, can be stored and analyzed for the delivery of status indicators 123.

A recipient of a status indicator 123 can also provide an input response to a displayed status indicator. For instance, a user may indicate that a particular status indicator was useful or not useful. Such feedback for a status indicator can be used to change the policy or the criteria used to filter the display of a status indicator. In one illustrative example, if a policy indicates that a status indicator should only be displayed for vacations at start within a week, and a recipient indicates such notifications are not useful, the system may update the policy to only show vacations at start within two weeks. Such changes can he made to the policy based on user feedback, which may be in the form of a voice command, or an input as shown in FIG. 9A. As shown, the routine 1000 can proceed from operation 1012 back to operation 1002 to enable the system 100 to continually utilize and adjust the machine learning data as new status indicators are generated.

It should be appreciated that the above-described subject matter may be implemented as a computer-controlled apparatus, a computer process, a computing system, or as an article of manufacture such as a computer-readable storage medium. The operations of the example methods are illustrated in individual blocks and summarized with reference to those blocks. The methods are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations.

Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) such as one or more internal or external CPUs or GPUs, and/or one or more pieces of hardware logic such as field-programmable gate arrays (“FPGAs”), digital signal processors (“DSPs”), or other types of accelerators.

All of the methods and processes described above may be embodied in, and fully automated via, software code modules executed by one or more general purpose computers or processors. The code modules may be stored in any type of computer-readable storage medium or other computer storage device, such as those described below. Some or all of the methods may alternatively be embodied in specialized computer hardware, such as that described below.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art.

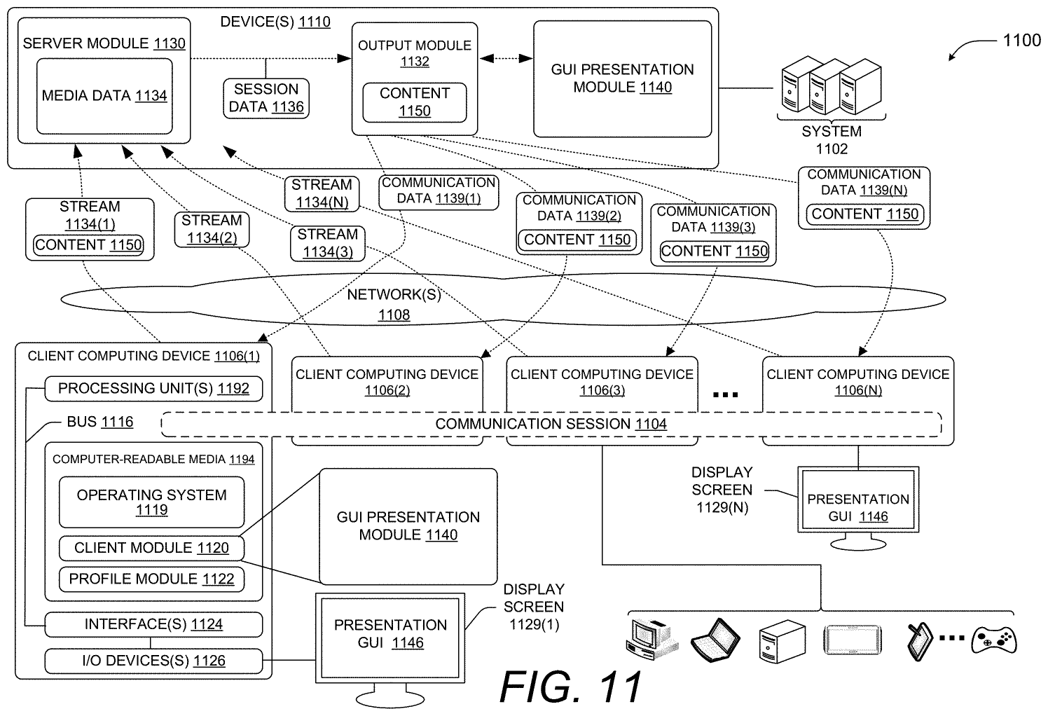

FIG. 11 is a diagram illustrating an example environment 1100 in which a system 1102 can implement the techniques disclosed herein. In some implementations, a system 1102 may function to collect, analyze, and share data defining one or more objects that are displayed to users of a communication session 1004.

As illustrated, the communication session 1103 may be implemented between a number of client computing devices 1106(1) through 1106(N) (where N is a number having a value of two or greater) that are associated with or are part of the system 1102. The client computing devices 1106(1) through 1106(N) enable users, also referred to as individuals, to participate in the communication session 1103.

In this example, the communication session 1103 is hosted, over one or more network(s) 1108, by the system 1102. That is, the system 1102 can provide a service that enables users of the client computing devices 1106(1) through 1106(N) to participate in the communication session 1103 (e.g., via a live viewing and/or a recorded viewing). Consequently, a “participant” to the communication session 1103 can comprise a user and/or a client computing device (e.g., multiple users may be in a room participating in a communication session via the use of a single client computing device), each of which can communicate with other participants. As an alternative, the communication session 1103 can be hosted by one of the client computing devices 1106(1) through 1106(N) utilizing peer-to-peer technologies. The system 1102 can also host chat conversations and other team collaboration functionality (e.g., as part of an application suite).

In some implementations, such chat conversations and other team collaboration functionality are considered external communication sessions distinct from the communication session 1103. A computing system 1102 that collects participant data in the communication session 1103 may be able to link to such external communication sessions. Therefore, the system may receive information, such as date, time, session particulars, and the like, that enables connectivity to such external communication sessions. In one example, a chat conversation can be conducted in accordance with the communication session 1103. Additionally, the system 1102 may host the communication session 1103, which includes at least a plurality of participants co-located at a meeting location, such as a meeting room or auditorium, or located in disparate locations.

In examples described herein, client computing devices 1106(1) through 1106(N) participating in the communication session 1103 are configured to receive and render for display, on a user interface of a display screen, communication data. The communication data can comprise a collection of various instances, or streams, of live content and/or recorded content. The collection of various instances, or streams, of live content and/or recorded content may be provided by one or more cameras, such as video cameras. For example, an individual stream of live or recorded content can comprise media data associated with a video feed provided by a video camera (e.g., audio and visual data that capture the appearance and speech of a user participating in the communication session). In some implementations, the video feeds may comprise such audio and visual data, one or more still images, and/or one or more avatars. The one or more still images may also comprise one or more avatars.

Another example of an individual stream of live or recorded content can comprise media data that includes an avatar of a user participating in the communication session along with audio data that captures the speech of the user. Yet another example of an individual stream of live or recorded content can comprise media data that includes a file displayed on a display screen along with audio data that captures the speech of a user. Accordingly, the various streams of live or recorded content within the communication data enable a remote meeting to be facilitated between a group of people and the sharing of content within the group of people. In some implementations, the various streams of live or recorded content within the communication data may originate from a plurality of co-located video cameras, positioned in a space, such as a room, to record or stream live a presentation that includes one or more individuals presenting and one or more individuals consuming presented content.

A participant or attendee can view content of the communication session 1103 live as activity occurs, or alternatively, via a recording at a later time after the activity occurs. In examples described herein, client computing devices 1106(1) through 1106(N) participating in the communication session 1103 are configured to receive and render for display, on a user interface of a display screen, communication data. The communication data can comprise a collection of various instances, or streams, of live and/or recorded content. For example, an individual stream of content can comprise media data associated with a video feed (e.g., audio and visual data that capture the appearance and speech of a user participating in the communication session). Another example of an individual stream of content can comprise media data that includes an avatar of a user participating in the conference session along with audio data that captures the speech of the user. Yet another example of an individual stream of content can comprise media data that includes a content item displayed on a display screen and/or audio data that captures the speech of a user. Accordingly, the various streams of content within the communication data enable a meeting or a broadcast presentation to be facilitated amongst a group of people dispersed across remote locations.

A participant or attendee to a communication session is a person that is in range of a camera, or other image and/or audio capture device such that actions and/or sounds of the person which are produced while the person is viewing and/or listening to the content being shared via the communication session can be captured (e.g., recorded). For instance, a participant may be sitting in a crowd viewing the shared content live at a broadcast location where a stage presentation occurs. Or a participant may be sitting in an office conference room viewing the shared content of a communication session with other colleagues via a display screen. Even further, a participant may be sitting or standing in front of a personal device (e.g., tablet, smartphone, computer, etc.) viewing the shared content of a communication session alone in their office or at home.

The system 1102 of FIG. 11 includes device(s) 1110. The device(s) 1110 and/or other components of the system 1102 can include distributed computing resources that communicate with one another and/or with the client computing devices 1106(1) through 1106(N) via the one or more network(s) 1108. In some examples, the system 1102 may be an independent system that is tasked with managing aspects of one or more communication sessions such as communication session 1103. As an example, the system 1102 may be managed by entities such as SLACK, WEBEX, GOTOMEETING, GOOGLE HANGOUTS, etc.

Network(s) 1108 may include, for example, public networks such as the Internet, private networks such as an institutional and/or personal intranet, or some combination of private and public networks. Network(s) 1108 may also include any type of wired and/or wireless network, including but not limited to local area networks (“LANs”), wide area networks (“WANs”), satellite networks, cable networks, Wi-Fi networks, WiMax networks, mobile communications networks (e.g., 3G, 4G, and so forth) or any combination thereof. Network(s) 1108 may utilize communications protocols, including packet-based and/or datagram-based protocols such as Internet protocol (“IP”), transmission control protocol (“TCP”), user datagram protocol (“UDP”), or other types of protocols. Moreover, network(s) 1108 may also include a number of devices that facilitate network communications and/or form a hardware basis for the networks, such as switches, routers, gateways, access points, firewalls, base stations, repeaters, backbone devices, and the like.

In some examples, network(s) 1108 may further include devices that enable connection to a wireless network, such as a wireless access point (“WAP”). Examples support connectivity through WAPs that send and receive data over various electromagnetic frequencies (e.g., radio frequencies), including WAPs that support Institute of Electrical and Electronics Engineers (“IEEE”) 802.11 standards (e.g., 802.11g, 802.11n, 802.11ac and so forth), and other standards.

In various examples, device(s) 1110 may include one or more computing devices that operate in a cluster or other grouped configuration to share resources, balance load, increase performance, provide fail-over support or redundancy, or for other purposes. For instance, device(s) 1110 may belong to a variety of classes of devices such as traditional server-type devices, desktop computer-type devices, and/or mobile-type devices. Thus, although illustrated as a single type of device or a server-type device, device(s) 1110 may include a diverse variety of device types and are not limited to a particular type of device. Device(s) 1110 may represent, but are not limited to, server computers, desktop computers, web-server computers, personal computers, mobile computers, laptop computers, tablet computers, or any other sort of computing device.

A client computing device (e.g., one of client computing device(s) 1106(1) through 1106(N)) (each of which are also referred to herein as a “data processing system”) may belong to a variety of classes of devices, which may be the same as, or different from, device(s) 1110, such as traditional client-type devices, desktop computer-type devices, mobile-type devices, special purpose-type devices, embedded-type devices, and/or wearable-type devices. Thus, a client computing device can include, but is not limited to, a desktop computer, a game console and/or a gaming device, a tablet computer, a personal data assistant (“PDA”), a mobile phone/tablet hybrid, a laptop computer, a telecommunication device, a computer navigation type client computing device such as a satellite-based navigation system including a global positioning system (“GPS”) device, a wearable device, a virtual reality (“VR”) device, an augmented reality (“AR”) device, an implanted computing device, an automotive computer, a network-enabled television, a thin client, a terminal, an Internet of Things (“IoT”) device, a work station, a media player, a personal video recorder (“PVR”), a set-top box, a camera, an integrated component (e.g., a peripheral device) for inclusion in a computing device, an appliance, or any other sort of computing device. Moreover, the client computing device may include a combination of the earlier listed examples of the client computing device such as, for example, desktop computer-type devices or a mobile-type device in combination with a wearable device, etc.

Client computing device(s) 1106(1) through 1106(N) of the various classes and device types can represent any type of computing device having one or more data processing unit(s) 1192 operably connected to computer-readable media 1194 such as via a bus 1116, which in some instances can include one or more of a system bus, a data bus, an address bus, a PCI bus, a Mini-PCI bus, and any variety of local, peripheral, and/or independent buses.

Executable instructions stored on computer-readable media 1194 may include, for example, an operating system 1119, a client module 1120, a profile module 1122, and other modules, programs, or applications that are loadable and executable by data processing units(s) 1192.

Client computing device(s) 1106(1) through 1106(N) may also include one or more interface(s) 1124 to enable communications between client computing device(s) 1106(1) through 1106(N) and other networked devices, such as device(s) 1110, over network(s) 1108. Such network interface(s) 1124 may include one or more network interface controllers (NICs) or other types of transceiver devices to send and receive communications and/or data over a network. Moreover, client computing device(s) 1106(1) through 1106(N) can include input/output (“I/O”) interfaces (devices) 1126 that enable communications with input/output devices such as user input devices including peripheral input devices (e.g., a game controller, a keyboard, a mouse, a pen, a voice input device such as a microphone, a video camera for obtaining and providing video feeds and/or still images, a touch input device, a gestural input device, and the like) and/or output devices including peripheral output devices (e.g., a display, a printer, audio speakers, a haptic output device, and the like). FIG. 11 illustrates that client computing device 1106(1) is in some way connected to a display device (e.g., a display screen 1129(N)), which can display a UI according to the techniques described herein.

In the example environment 1100 of FIG. 11, client computing devices 1106(1) through 1106(N) may use their respective client modules 1120 to connect with one another and/or other external device(s) in order to participate in the communication session 1103, or in order to contribute activity to a collaboration environment. For instance, a first user may utilize a client computing device 1106(1) to communicate with a second user of another client computing device 1106(2). When executing client modules 1120, the users may share data, which may cause the client computing device 1106(1) to connect to the system 1102 and/or the other client computing devices 1106(2) through 1106(N) over the network(s) 1108.

The client computing device(s) 1106(1) through 1106(N) may use their respective profile modules 1122 to generate participant profiles (not shown in FIG. 11) and provide the participant profiles to other client computing devices and/or to the device(s) 1110 of the system 1102. A participant profile may include one or more of an identity of a user or a group of users (e.g., a name, a unique identifier (“ID”), etc.), user data such as personal data, machine data such as location (e.g., an IP address, a room in a building, etc.) and technical capabilities, etc. Participant profiles may be utilized to register participants for communication sessions.

As shown in FIG. 11, the device(s) 1110 of the system 1102 include a server module 1130 and an output module 1132. In this example, the server module 1130 is configured to receive, from individual client computing devices such as client computing devices 1106(1) through 1106(N), media streams 1134(1) through 1134(N). As described above, media streams can comprise a video feed (e.g., audio and visual data associated with a user), audio data which is to be output with a presentation of an avatar of a user (e.g., an audio only experience in which video data of the user is not transmitted), text data (e.g., text messages), file data and/or screen sharing data (e.g., a document, a slide deck, an image, a video displayed on a display screen, etc.), and so forth. Thus, the server module 1130 is configured to receive a collection of various media streams 1134(1) through 1134(N) during a live viewing of the communication session 1103 (the collection being referred to herein as “media data 1134”). In some scenarios, not all of the client computing devices that participate in the communication session 1103 provide a media stream. For example, a client computing device may only be a consuming, or a “listening”, device such that it only receives content associated with the communication session 1103 but does not provide any content to the communication session 1103.

In various examples, the server module 1130 can select aspects of the media streams 1134 that are to be shared with individual ones of the participating client computing devices 1106(1) through 1106(N). Consequently, the server module 1130 may be configured to generate session data 1136 based on the streams 1134 and/or pass the session data 1136 to the output module 1132. Then, the output module 1132 may communicate communication data 1139 to the client computing devices (e.g., client computing devices 1106(1) through 1106(3) participating in a live viewing of the communication session). The communication data 1139 may include video, audio, and/or other content data, provided by the output module 1132 based on content 1150 associated with the output module 1132 and based on received session data 1136.

As shown, the output module 1132 transmits communication data 1139(1) to client computing device 1106(1), and transmits communication data 1139(2) to client computing device 1106(2), and transmits communication data 1139(3) to client computing device 1106(3), etc. The communication data 1139 transmitted to the client computing devices can be the same or can be different (e.g., positioning of streams of content within a user interface may vary from one device to the next).

In various implementations, the device(s) 1110 and/or the client module 1120 can include GUI presentation module 1140. The GUI presentation module 1140 may be configured to analyze communication data 1139 that is for delivery to one or more of the client computing devices 1106. Specifically, the UI presentation module 1140, at the device(s) 1110 and/or the client computing device 1106, may analyze communication data 1139 to determine an appropriate manner for displaying video, image, and/or content on the display screen 1129 of an associated client computing device 1106. In some implementations, the GUI presentation module 1140 may provide video, image, and/or content to a presentation GUI 1146 rendered on the display screen 1129 of the associated client computing device 1106. The presentation GUI 1146 may be caused to be rendered on the display screen 1129 by the GUI presentation module 1140. The presentation GUI 1146 may include the video, image, and/or content analyzed by the GUI presentation module 1140.

In some implementations, the presentation GUI 1146 may include a plurality of sections or grids that may render or comprise video, image, and/or content for display on the display screen 1129. For example, a first section of the presentation GUI 1146 may include a video feed of a presenter or individual, a second section of the presentation GUI 1146 may include a video feed of an individual consuming meeting information provided by the presenter or individual. The GUI presentation module 1140 may populate the first and second sections of the presentation GUI 1146 in a manner that properly imitates an environment experience that the presenter and the individual may be sharing.

In some implementations, the GUI presentation module 1140 may enlarge or provide a zoomed view of the individual represented by the video feed in order to highlight a reaction, such as a facial feature, the individual had to the presenter. In some implementations, the presentation GUI 1146 may include a video feed of a plurality of participants associated with a meeting, such as a general communication session. In other implementations, the presentation GUI 1146 may be associated with a channel, such as a chat channel, enterprise teams channel, or the like. Therefore, the presentation GUI 1146 may be associated with an external communication session that is different than the general communication session.

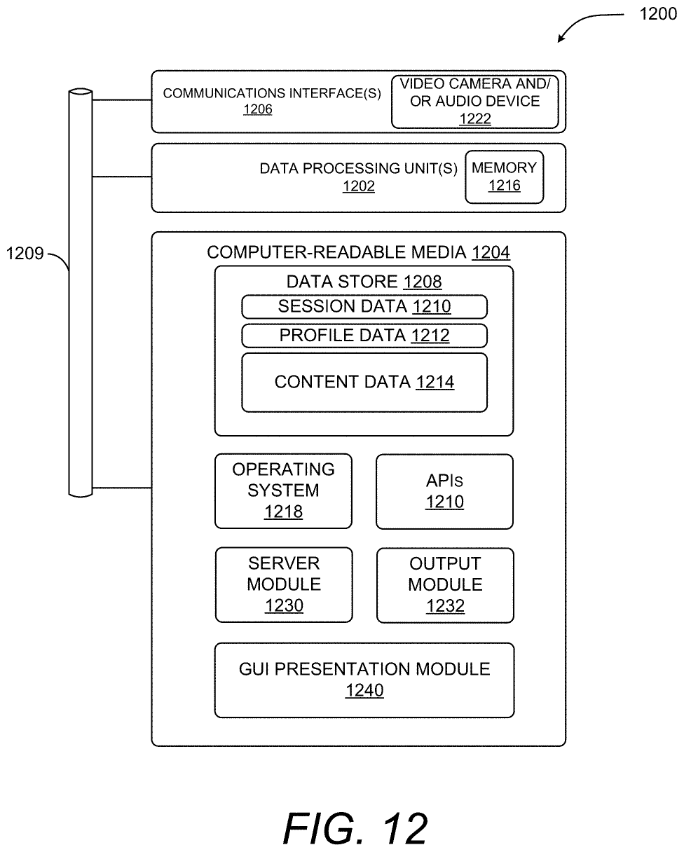

FIG. 12 illustrates a diagram that shows example components of an example device 1200 (also referred to herein as a “computing device”) configured to generate data for some of the user interfaces disclosed herein. The device 1200 may generate data that may include one or more sections that may render or comprise video, images, virtual objects, and/or content for display on the display screen 1129. The device 1200 may represent one of the device(s) described herein. Additionally, or alternatively, the device 1200 may represent one of the client computing devices 1106.

As illustrated, the device 1200 includes one or more data processing unit(s) 1202, computer-readable media 1204, and communication interface(s) 1206. The components of the device 1200 are operatively connected, for example, via a bus 1209, which may include one or more of a system bus, a data bus, an address bus, a PCI bus, a Mini-PCI bus, and any variety of local, peripheral, and/or independent buses.

As utilized herein, data processing unit(s), such as the data processing unit(s) 1202 and/or data processing unit(s) 1192, may represent, for example, a CPU-type data processing unit, a GPU-type data processing unit, a field-programmable gate array (“FPGA”), another class of DSP, or other hardware logic components that may, in some instances, be driven by a CPU. For example, and without limitation, illustrative types of hardware logic components that may be utilized include Application-Specific Integrated Circuits (“ASICs”), Application-Specific Standard Products (“ASSPs”), System-on-a-Chip Systems (“SOCs”), Complex Programmable Logic Devices (“CPLDs”), etc.

As utilized herein, computer-readable media, such as computer-readable media 1204 and computer-readable media 1194, may store instructions executable by the data processing unit(s). The computer-readable media may also store instructions executable by external data processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media, which might also be referred to herein as a computer-readable medium, may include computer storage media and/or communication media. Computer storage media may include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

Communication interface(s) 1206 may represent, for example, network interface controllers (“NICs”) or other types of transceiver devices to send and receive communications over a network. Furthermore, the communication interface(s) 1206 may include one or more video cameras and/or audio devices 1222 to enable generation of video feeds and/or still images, and so forth.

In the illustrated example, computer-readable media 1204 includes a data store 1208. In some examples, the data store 1208 includes data storage such as a database, data warehouse, or other type of structured or unstructured data storage. In some examples, the data store 1208 includes a corpus and/or a relational database with one or more tables, indices, stored procedures, and so forth to enable data access including one or more of hypertext markup language (“HTML”) tables, resource description framework (“RDF”) tables, web ontology language (“OWL”) tables, and/or extensible markup language (“XML”) tables, for example.

The data store 1208 may store data for the operations of processes, applications, components, and/or modules stored in computer-readable media 1204 and/or executed by data processing unit(s) 1202 and/or accelerator(s). For instance, in some examples, the data store 1208 may store session data 1210 (e.g., session data 1136 as shown in FIG. 11), profile data 1212 (e.g., associated with a participant profile), and/or other data. The session data 1210 can include a total number of participants (e.g., users and/or client computing devices) in a communication session, activity that occurs in the communication session, a list of invitees to the communication session, and/or other data related to when and how the communication session is conducted or hosted. The data store 1208 may also include content data 1214, such as the content that includes video, audio, or other content for rendering and display on one or more of the display screens 1129.

Alternately, some or all of the above-referenced data can be stored on separate memories 1216 on board one or more data processing unit(s) 1202 such as a memory on board a CPU-type processor, a GPU-type processor, an FPGA-type accelerator, a DSP-type accelerator, and/or another accelerator. In this example, the computer-readable media 1204 also includes an operating system 1218 and application programming interface(s) 1210 (APIs) configured to expose the functionality and the data of the device 1200 to other devices. Additionally, the computer-readable media 1204 includes one or more modules such as the server module 1230, the output module 1232, and the GUI presentation module 1240, although the number of illustrated modules is just an example, and the number may vary higher or lower. That is, functionality described herein in association with the illustrated modules may be performed by a fewer number of modules or a larger number of modules on one device or spread across multiple devices.

It should also be appreciated that many variations and modifications may be made to the above-described examples, the elements of which are to be understood as being among other acceptable examples. All such modifications and variations are intended to be included herein within the scope of this disclosure and protected by the following claims.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

The disclosure presented herein also encompasses the subject matter set forth in the following clauses:

Clause 1: A method for providing a status indicator, the method performed by a data processing system comprising: analyzing contextual data, including communication data or calendar data, to determine a time and a duration of a status associated with a user identity; determining that the time of the status meets one or more criteria; in response to determining that the time of the status meets the one or more criteria, causing a display of the status indicator on a user interface rendered on a display device, the status indicator providing the user identity, the time of the status, and the duration of the status.

Clause 2: The method of clause 1, wherein the one or more criteria defines the duration as a period of unavailability of a user associated with the user identity, wherein the status meets the one or more criteria when the duration of the status exceeds a minimum time threshold.

Clause 3: The method of clauses 1 and 2, wherein the status meets one or more criteria when the contextual data indicates that the time of the status is within a threshold period of the time with respect to a current time, wherein the status indicator further indicates a duration between the current time and the time of the status.

Clause 4: The method of clauses 1-3, wherein the status meets one or more criteria when activity data, including voice communications or text communications, indicates a deadline that is within a threshold period of the time of the status, wherein the status indicator further indicates a duration between a current time and the time of the status.

Clause 5: The method of clauses 1-4, wherein the contextual data indicates a time of a second status associated with a second user identity, wherein the status meets one or more criteria when the duration of the status overlaps with a duration of the second status, and wherein the status indicator further indicates an overlap between the duration of the status and the duration of the second status.

Clause 6: The method of clauses 1-5, wherein the contextual data indicates a timeline for the status, the timeline having a start time and an end time, wherein the status meets one or more criteria when the end time is within a threshold period of the time of a current time, wherein the status indicator further indicates a duration between the current time and the end time of the status.

Clause 7: The method of clauses 1-6, wherein the display of the status indicator is further in response to receiving a user input identifying the user identity.

Clause 8: The method of clauses 1-7, further comprising: selecting a delivery mechanism for the display of the status indicator, the delivery mechanism comprising an application or a file, wherein the selection of the delivery mechanism is based on at least one of a frequency of use, a time of use, a level of relevancy between the delivery mechanism and a topic identified by activity data associated with the user, wherein the status indicator is displayed within the user interface displaying the application or the user interface displaying the file.

Clause 9: A method for providing a status indicator, the method performed by a data processing system comprising: monitoring activity data for determining that a collaboration level plurality of users exceeds a collaboration threshold; in response to determining that the collaboration level of the plurality of users exceeds the collaboration threshold, analyzing contextual data, including communication data and calendar data, to determine a time of a status associated with a user identity of one user of the plurality of users; determining that the time of the status meets one or more criteria; in response to determining that the time of the status meets one or more criteria, causing a display of the status indicator on a user interface rendered on a display device, the status indicator providing the user identity, the time of the status, and a duration of the status.

Clause 10: The method of clause 9, wherein the collaboration level is based on a number of documents shared between the plurality of users, and wherein the collaboration threshold is a predetermined number of documents.

Clause 11: The method of clauses 9 and 10, wherein the collaboration level is based on a quantity of data exchanged between the plurality of users, and wherein the collaboration threshold is a predetermined number of documents.

Clause 12: The method of clauses 9-11, wherein the collaboration level is based on a frequency of communication sessions between the plurality of users, and wherein the collaboration threshold is a predetermined frequency of communication sessions.

Clause 13: The method of clauses 9-12, wherein the collaboration level is based on a number of communication sessions between the plurality of users, and wherein the collaboration threshold is a predetermined number of communication sessions between the plurality of users.

Clause 14: The method of clauses 9-13, further comprising: selecting a delivery mechanism for the display of the status indicator, the delivery mechanism comprising an application or a file, wherein the selection of the delivery mechanism is based on at least one of a frequency of use, a time of use, a level of relevancy between the delivery mechanism and a topic identified by activity data associated with the user, wherein the status indicator is displayed within the user interface displaying the application or the user interface displaying the file.

Clause 15: The method of clauses 9-14, the collaboration level is based on a number of different communication sessions between the plurality of users, and wherein the collaboration threshold is a predetermined number of different communication sessions between the plurality of users.

Clause 16: A system comprising: means for analyzing contextual data, including communication data and calendar data, to determine a time of a status associated with a user identity; means for determining that the time of the status meets one or more criteria; means for causing a display of the status indicator on a user interface rendered on a display device, the status indicator providing the user identity, the time of the status, wherein the display of the status indicator is in response to determining that the time of the status meets the one or more criteria.

Clause 17: The system of clause 16, wherein the one or more criteria defines the duration as a period of unavailability of a user associated with the user identity, wherein the status meets the one or more criteria when the duration of the status exceeds a minimum time threshold.

Clause 18: The system of clauses 16 and 17, wherein the status meets one or more criteria when the contextual data indicates that the time of the status is within a threshold period of the time with respect to a current time, wherein the status indicator further indicates a duration between the current time and the time of the status.

Clause 19: The system of clauses 16-18, wherein the status meets one or more criteria when activity data, including voice communications or text communications, indicates a deadline that is within a threshold period of the time of the status, wherein the status indicator further indicates a duration between a current time and the time of the status.

Clause 20: The system of clauses 16-19, wherein the contextual data indicates a time of a second status associated with a second user identity, wherein the status meets one or more criteria when the duration of the status overlaps with a duration of the second status, and wherein the status indicator further indicates an overlap between the duration of the status and the duration of the second status.

It should also be appreciated that many variations and modifications may be made to the above-described examples, the elements of which are to be understood as being among other acceptable examples. All such modifications and variations are intended to be included herein within the scope of this disclosure and protected by the following claims.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A method for providing a status indicator, the method performed by a data processing system comprising:
analyzing contextual data, including communication data or calendar data, to determine a time and a duration of a status associated with a user identity;
determining that the time of the status meets one or more criteria;
in response to determining that the time of the status meets the one or more criteria, causing a display of the status indicator on a user interface rendered on a display device, the status indicator providing the user identity, the time of the status, and the duration of the status.

2. The method of claim 1, wherein the one or more criteria defines the duration as a period of unavailability of a user associated with the user identity, wherein the status meets the one or more criteria when the duration of the status exceeds a minimum time threshold.

3. The method of claim 1, wherein the status meets one or more criteria when the contextual data indicates that the time of the status is within a threshold period of the time with respect to a current time, wherein the status indicator further indicates a duration between the current time and the time of the status.

4. The method of claim 1, wherein the status meets one or more criteria when activity data, including voice communications or text communications, indicates a deadline that is within a threshold period of the time of the status, wherein the status indicator further indicates a duration between a current time and the time of the status.

5. The method of claim 1, wherein the contextual data indicates a time of a second status associated with a second user identity, wherein the status meets one or more criteria when the duration of the status overlaps with a duration of the second status, and wherein the status indicator further indicates an overlap between the duration of the status and the duration of the second status.

6. The method of claim 1, wherein the contextual data indicates a timeline for the status, the timeline having a start time and an end time, wherein the status meets one or more criteria when the end time is within a threshold period of the time of a current time, wherein the status indicator further indicates a duration between the current time and the end time of the status.

7. The method of claim 1, wherein the display of the status indicator is further in response to receiving a user input identifying the user identity.

8. The method of claim 1, further comprising: selecting a delivery mechanism for the display of the status indicator, the delivery mechanism comprising an application or a file, wherein the selection of the delivery mechanism is based on at least one of a frequency of use, a time of use, a level of relevancy between the delivery mechanism and a topic identified by activity data associated with the user, wherein the status indicator is displayed within the user interface displaying the application or the user interface displaying the file.

9. A method for providing a status indicator, the method performed by a data processing system comprising:
monitoring activity data for determining that a collaboration level plurality of users exceeds a collaboration threshold;
in response to determining that the collaboration level of the plurality of users exceeds the collaboration threshold, analyzing contextual data, including communication data and calendar data, to determine a time of a status associated with a user identity of one user of the plurality of users;
determining that the time of the status meets one or more criteria;
in response to determining that the time of the status meets one or more criteria, causing a display of the status indicator on a user interface rendered on a display device, the status indicator providing the user identity, the time of the status, and a duration of the status.

10. The method of claim 9, wherein the collaboration level is based on a number of documents shared between the plurality of users, and wherein the collaboration threshold is a predetermined number of documents.

11. The method of claim 9, wherein the collaboration level is based on a quantity of data exchanged between the plurality of users, and wherein the collaboration threshold is a predetermined number of documents.

12. The method of claim 9, wherein the collaboration level is based on a frequency of communication sessions between the plurality of users, and wherein the collaboration threshold is a predetermined frequency of communication sessions.

13. The method of claim 9, wherein the collaboration level is based on a number of communication sessions between the plurality of users, and wherein the collaboration threshold is a predetermined number of communication sessions between the plurality of users.

14. The method of claim 9, further comprising: selecting a delivery mechanism for the display of the status indicator, the delivery mechanism comprising an application or a file, wherein the selection of the delivery mechanism is based on at least one of a frequency of use, a time of use, a level of relevancy between the delivery mechanism and a topic identified by activity data associated with the user, wherein the status indicator is displayed within the user interface displaying the application or the user interface displaying the file.

15. The method of claim 9, the collaboration level is based on a number of different communication sessions between the plurality of users, and wherein the collaboration threshold is a predetermined number of different communication sessions between the plurality of users.

16. A system comprising:
means for analyzing contextual data, including communication data and calendar data, to determine a time of a status associated with a user identity;
means for determining that the time of the status meets one or more criteria;
means for causing a display of the status indicator on a user interface rendered on a display device, the status indicator providing the user identity, the time of the status, wherein the display of the status indicator is in response to determining that the time of the status meets the one or more criteria.

17. The system of claim 16, wherein the one or more criteria defines the duration as a period of unavailability of a user associated with the user identity, wherein the status meets the one or more criteria when the duration of the status exceeds a minimum time threshold.

18. The system of claim 16, wherein the status meets one or more criteria when the contextual data indicates that the time of the status is within a threshold period of the time with respect to a current time, wherein the status indicator further indicates a duration between the current time and the time of the status.

19. The system of claim 18, wherein the status meets one or more criteria when activity data, including voice communications or text communications, indicates a deadline that is within a threshold period of the time of the status, wherein the status indicator further indicates a duration between a current time and the time of the status.

20. The system of claim 16, wherein the contextual data indicates a time of a second status associated with a second user identity, wherein the status meets one or more criteria when the duration of the status overlaps with a duration of the second status, and wherein the status indicator further indicates an overlap between the duration of the status and the duration of the second status.
